(19) United States
(12) Patent Application Publication
(10) Pub. No.: US 2024/0340795 A1
(43) Pub. Date: Oct. 10, 2024

(54) METHOD AND APPARATUS FOR SUPPORTING NETWORK ENERGY SAVING FUNCTION IN COMMUNICATION NETWORK

(71) Applicant: Electronics and Telecommunications Research Institute, Daejeon (KR)

(72) Inventor: Jae Heung KIM, Daejeon (KR)

(21) Appl. No.: 18/626,195

(22) Filed: Apr. 3, 2024

(30) Foreign Application Priority Data
Apr. 4, 2023 (KR) 10-2023-0044364
Apr. 1, 2024 (KR) 10-2024-0044179

(51) Int. Cl. H04W 52/02; H04L 1/08; H04W 56/00; H04W 76/28

(52) U.S. Cl. CPC H04W 52/0235; H04L 1/08; H04W 56/0015; H04W 76/28

(57) ABSTRACT

A method of a network node may comprise: transmitting first control information to one or more terminals including a network energy saving (NES) terminal, the first control information including information on whether the NES terminal supporting an NES operation is allowed to perform an access procedure to the network node; and in response to that the NES terminal is allowed to perform an access procedure to the network node, performing the access procedure with the NES terminal.

### CROSS-REFERENCE TO RELATED APPLICATIONS

This application claims priority to Korean Patent Applications No. 10-2023-0044364, filed on Apr. 4, 2023, and No. 10-2024-0044179, filed on Apr. 1, 2024, with the Korean Intellectual Property Office (KIPO), the entire contents of which are hereby incorporated by reference.

### BACKGROUND

### 1. Technical Field

The present disclosure relates to an energy saving technique, and more particularly, to a technique for supporting network energy saving (NES) functionality in a communication network.

### 2. Related Art

In order to overcome performance degradation due to interference in a wireless channel due to the rapid increase in the number of users and wireless data and to improve terminal performance at a boundary of a base station (or cell), a plurality of small base stations and/or radio access points may be introduced into a communication network. A small base station may refer to a small cell. A radio access point may refer to a transmission and reception point (TRP), remote radio head (RRH), relay, and/or repeater.

The small cell and/or radio access point may support a small service coverage. Instead of a small cell and/or radio access point that implements all wireless protocol functions, a small cell or radio access point supporting functional split, carrier aggregation (CA), dual connectivity (DC), and/or duplication transmission (DT) may be deployed in the communication network. When the functional split is applied, functions of a base station (e.g., small cell, radio access point) may be distributed into a plurality of remote wireless transmit/receive blocks and one centralized baseband processing functional block.

Various types of base stations (e.g., small cells, radio access points) may be deployed in the communications network. To support mobility functions and/or provide high-capacity services in the communication network, energy consumption of the communication network may rapidly increase. Methods for saving energy at each node in the communication network will be needed.

### SUMMARY

The present disclosure for resolving the above-described problems is directed to providing a method and an apparatus for supporting network energy saving (NES) functionality in a communication network.

A method of a network node according to exemplary embodiments of the present disclosure for achieving the above-described objective may comprise: transmitting first control information to one or more terminals including a network energy saving (NES) terminal, the first control information including information on whether the NES terminal supporting an NES operation is allowed to perform an access procedure to the network node; and in response to that the NES terminal is allowed to perform an access procedure to the network node, performing the access procedure with the NES terminal.

Even when the NES terminal is allowed to perform an access procedure to the network node, an access procedure of a non-NES terminal that does not support the NES operation among the one or more terminals may be restricted from being performed to the network node.

The first control information including the information on whether the NES terminal is allowed to perform an access procedure to the network node may be a system information block (SIB).

The method may further comprise: transmitting, to the one or more terminals, second control information indicating activation of the NES operation, wherein the second control information may be included in a radio resource control (RRC) signaling message or a layer (L1) group common signaling message.

The method may further comprise: transmitting, to the one or more terminals, third control information indicating deactivation of the NES operation, wherein the third control information may be included in an RRC signaling message or an L1 group common signaling message.

The NES operation may include a cell discontinuous transmission (DTX)/discontinuous reception (DRX) operation, and an active period for the cell DTX/DRX operation may partially overlap an on-duration for a user equipment (UE) DRX operation.

The NES operation may be applied to a cell where a synchronization signal block (SSB) is not transmitted.

The method may further comprise: performing communication with the NES terminal in an active period for a cell DTX/DRX operation which is the NES operation; and performing restricted communication with the NES terminal in a non-active period for the cell DTX/DRX operation.

The restricted communication may include at least one of a retransmission operation for data transmission failed in the active period, a retransmission operation when a retransmission timer is running in the inactive period, or a retransmission operation using an uplink resource allocated by dynamic scheduling of the network node in the inactive period.

A method of a first terminal according to exemplary embodiments of the present disclosure for achieving the above-described objective may comprise: receiving first control information from a network node, the first control information including information on whether a network energy saving (NES) terminal supporting an NES operation is allowed to perform an access procedure to the network node; and in response to that an NES terminal is allowed to perform an access procedure to the network node, and the first terminal is an NES terminal, performing an access procedure to the network node.

The first control information including the information on whether an NES terminal is allowed to perform an access procedure to the network node may be a system information block (SIB).

The method may further comprise: receiving, from the network node, second control information indicating activation of the NES operation, wherein the second control information may be included in a radio resource control (RRC) signaling message or a layer (L1) group common signaling message.

The method may further comprise: receiving, from the network node, third control information indicating deactivation of the NES operation, wherein the third control information may be included in an RRC signaling message or an L1 group common signaling message.

The NES operation may include a cell discontinuous transmission (DTX)/discontinuous reception (DRX) operation, and an active period for the cell DTX/DRX operation may partially overlap an on-duration for a user equipment (UE) DRX operation.

The NES operation may be applied to a cell where a synchronization signal block (SSB) is not transmitted.

The method may further comprise: performing communication with the network node in an active period for a cell DTX/DRX operation which is the NES operation; and performing restricted communication with the network node in a non-active period for the cell DTX/DRX operation.

The restricted communication may include at least one of a retransmission operation for data transmission failed in the active period, a retransmission operation when a retransmission timer is running in the inactive period, or a retransmission operation using an uplink resource allocated by dynamic scheduling of the network node in the inactive period.

A first terminal according to exemplary embodiments of the present disclosure for achieving the above-described objective may comprise: at least one processor, and the at least one processor may cause the first terminal to perform: receiving first control information from a network node, the first control information including information on whether a network energy saving (NES) terminal supporting an NES operation is allowed to perform an access procedure to the network node; and in response to that an NES terminal is allowed to perform an access procedure to the network node, and the first terminal is an NES terminal, performing an access procedure to the network node.

The NES operation may include a cell discontinuous transmission (DTX)/discontinuous reception (DRX) operation, and an active period for the cell DTX/DRX operation may partially overlap an on-duration for a user equipment (UE) DRX operation.

The at least one processor may further cause the first terminal to perform: performing communication with the network node in an active period for a cell DTX/DRX operation which is the NES operation; and performing restricted communication with the network node in a non-active period for the cell DTX/DRX operation, wherein the restricted communication includes at least one of a retransmission operation for data transmission failed in the active period, a retransmission operation when a retransmission timer is running in the inactive period, or a retransmission operation using an uplink resource allocated by dynamic scheduling of the network node in the inactive period.

According to the present disclosure, functional split can be applied in a communication network. In the communication network, an NES operation that takes into account states of terminals can be performed in a channel (e.g., wireless channel) between each network node (e.g., base station, small cell, radio access point, relay) and a terminal. The parameter(s) for NES operation can be set, and the parameter(s) can be signaled to each node (e.g., base station, small cell, radio access point, relay, terminal). The NES operation can be performed based on the signaled parameter(s). According to the NES operation, the energy consumption of each node in the communication network can be efficiently reduced.

### BRIEF DESCRIPTION OF DRAWINGS

FIG. 1 is a conceptual diagram illustrating exemplary embodiments of a communication network.

FIG. 2 is a block diagram illustrating exemplary embodiments of an apparatus.

FIG. 3 is a conceptual diagram illustrating exemplary embodiments of operation states of a terminal in a communication network.

FIG. 4 is a conceptual diagram illustrating exemplary embodiments of a method for configuring bandwidth parts (BWPs) in a communication network.

FIG. 5 is a conceptual diagram illustrating exemplary embodiments of a communication network.

FIG. 6 is a conceptual diagram illustrating exemplary embodiments of a method of providing a service using a plurality of radio access points in a communication network.

FIG. 7 is a conceptual diagram illustrating exemplary embodiments of DTX/DRX operations in a communication network.

FIG. 8 is a conceptual diagram illustrating exemplary embodiments of a method for configuring a hierarchical beam for NES in a communication network.

FIGS. 9A and 9B are sequence charts illustrating exemplary embodiments of an NES operation.

FIGS. 10A and 10B are sequence charts illustrating exemplary embodiments of an NES operation.

FIG. 11 is a conceptual diagram illustrating exemplary embodiments of DTX/DRX operations in a communication network.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and redundant description thereof will be omitted.

A communication network to which exemplary embodiments according to the present disclosure are applied will be described. The communication network may be the 4G communication network (e.g., Long-Term Evolution (LTE) communication network or LTE-A communication network), the 5G communication network (e.g., New Radio (NR) communication network), the sixth generation (6G) communication network, or the like. The 4G communication network may support communications in a frequency band of 6 GHz or below, and the 5G communication network may support communications in a frequency band of 6 GHz or above as well as the frequency band of 6 GHz or below. The communication network to which the exemplary embodiments according to the present disclosure are applied is not limited to the contents described below, and the exemplary embodiments according to the present disclosure may be applied to various communication networks. Here, the communication network may be used in the same sense as a communication system and/or wireless access system. ‘LTE’ may refer to ‘4G communication network’, ‘LTE communication network’, or ‘LTE-A communication network’, and ‘NR’ may refer to ‘5G communication network’ or ‘NR communication network’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. ‘Configuration of information element(s) (e.g., parameter(s))’ may mean that the corresponding information element(s) are signaled. ‘Configuration of a resource (e.g., resource region)’ may mean that configuration information of the corresponding resource is signaled. The signaling may be performed based on at least one of system information (SI) signaling (e.g., transmission of system information block (SIB) and/or master information block (MIB)), RRC signaling (e.g., transmission of RRC parameters and/or higher layer parameters), MAC control element (CE) signaling, PHY signaling (e.g., transmission of downlink control information (DCI), uplink control information (UCI), and/or sidelink control information (SCI)), or a combination thereof.

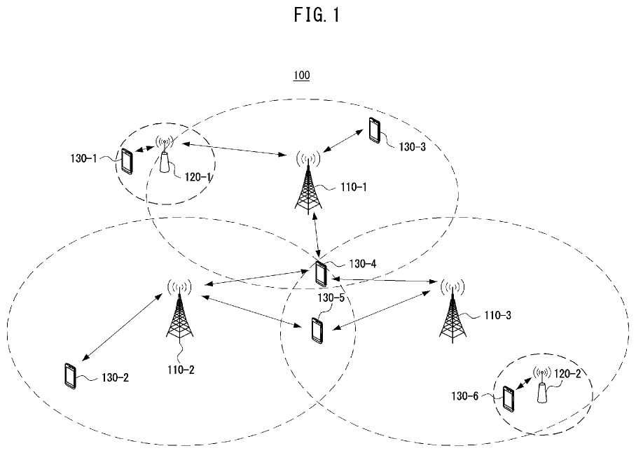

FIG. 1 is a conceptual diagram illustrating exemplary embodiments of a communication network.

Referring to FIG. 1, a communication network 100 may comprise a plurality of communication nodes 110-1, 110-2, 110-3, 120-1, 120-2, 130-1, 130-2, 130-3, 130-4, 130-5, and 130-6. Also, the communication network 100 may further comprise a core network (e.g., a serving gateway (S-GW), a packet data network (PDN) gateway (P-GW), and a mobility management entity (MME)). When the communication network 100 is a 5G communication network (e.g., New Radio (NR) network), the core network may include an access and mobility management function (AMF), a user plane function (UPF), a session management function (SMF), and the like. The communication network 100 may refer to a radio access network (RAN).

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

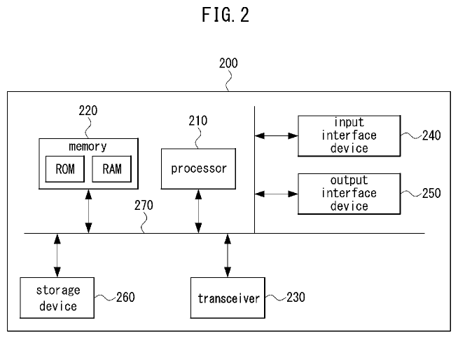

FIG. 2 is a block diagram illustrating exemplary embodiments of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication network 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to operations of the plurality of base stations 110-1, 110-2, 110-3, 120-1, and 120-2, operations supported by the plurality of base stations 110-1, 110-2, 110-3, 120-1, and 120-2, or the like. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

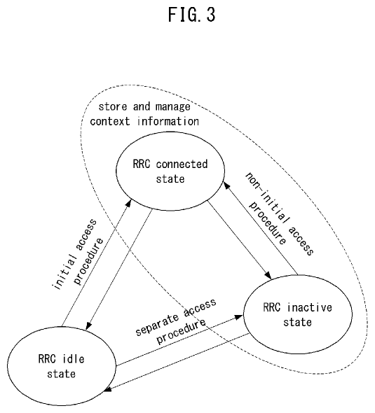

FIG. 3 is a conceptual diagram illustrating exemplary embodiments of operation states of a terminal in a communication network.

Referring to FIG. 3, in a radio resource control (RRC) layer of the communication network, states (e.g., operation states) of a terminal may be classified into an RRC connected state, RRC inactive state, and RRC idle state. When the terminal operates in the RRC connected state or the RRC inactive state, a base station of a RAN and the terminal may store and/or manage at least one of RRC connection configuration information, RRC context information, or access stratum (AS) context information of the terminal.

In the RRC connected state, the terminal may receive allocation information of physical layer control channels and/or reference signals necessary for maintaining RRC connection configuration and/or transmitting and receiving packets (e.g., data). The reference signal may be a reference signal for demodulating data, a reference signal for measuring a channel quality, and/or a reference signal for beamforming. The terminal in the RRC connected state may be able to transmit and receive packets (e.g., data) without additional delay. In the present disclosure, the packet may refer to data, data unit, and/or information.

In the RRC inactive state, the terminal may perform a mobility management function corresponding to the RRC idle state. Although the terminal in the RRC inactive state is in a state of being connected to the base station, a data bearer for transmitting and receiving packets may not be configured in the terminal in the RRC inactive state, and functions such as the MAC layer may be inactivated in the terminal in the RRC inactive state. In order to transmit data, the terminal in the RRC inactive state may transition to the RRC connected state by performing a non-initial access procedure. Alternatively, the terminal in the RRC inactive state may transmit limited data allowed in the RRC inactive state. The limited data may be data having a limited size, data having a limited quality of service, and/or data belonging to a limited type of service.

From the perspective of the radio access network, a connection established between the terminal in the RRC idle state and the base station may not exist. Connection configuration information and/or context information (e.g., RRC context information, AS context information) for the terminal in the RRC idle state may not be stored in the base station and/or a control function block of the radio access network. The terminal in the RRC idle state may perform an initial access procedure to transition to the RRC connected state. Although the terminal in the RRC idle state performs an initial access procedure to transition to the RRC connected state, the state of the terminal may transition from the RRC idle state to the RRC inactive state according to determination of the base station.

The terminal in the RRC idle state may transition to the RRC inactive state by performing an initial access procedure or a separate access procedure defined for transition to the RRC inactive state. When a limited service is provided to the terminal, the operation state of the terminal may transition from the RRC idle state to the RRC inactive state. Alternatively, the operation state of the terminal may transition from the RRC idle state to the RRC inactive state according to capability of the terminal.

The base station and/or the control function block of the radio access network may configure condition(s) by which the terminal can transition to the RRC inactive state in consideration of one or more of the type, capability, and/or service (e.g., service currently being provided, service to be provided) of the terminal, and may control the transition operation to the RRC inactive state based on the configured condition(s). When the base station allows transition to the RRC inactive state or when it is configured to be able to transition to the RRC inactive state, the operation state of the terminal may transition from the RRC connected state or the RRC idle state to the RRC inactive state.

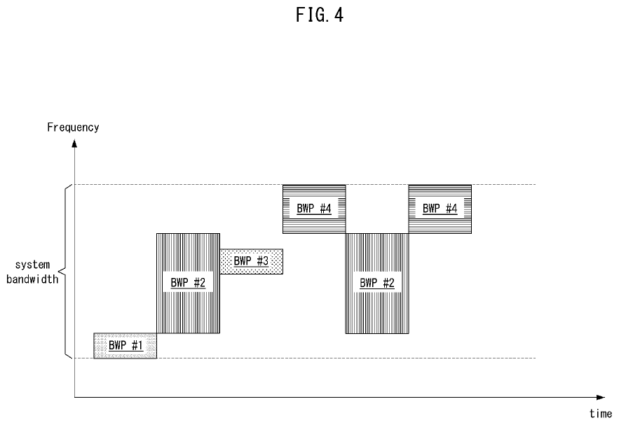

FIG. 4 is a conceptual diagram illustrating exemplary embodiments of a method for configuring bandwidth parts (BWPs) in a communication network.

Referring to FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings (SCSs) may be applied to the BWPs #1 to #4. For example, the bandwidth of the BWP #1 may be 10 MHz, and the BWP #1 may have a 15 kHz SCS. The bandwidth of the BWP #2 may be 40 MHZ, and the BWP #2 may have a 15 kHz SCS. The bandwidth of the BWP #3 may be 10 MHZ, and the BWP #3 may have a 30 KHz SCS. The bandwidth of the BWP #4 may be 20 MHz, and the BWP #4 may have a 60 KHz SCS.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

When a random access (RA) resource is not configured in the active uplink (UL) BWP in the NR communication network, the terminal may switch the operating BWP of the terminal from the active UL BWP to the initial UL BWP in order to perform a random access procedure. The operating BWP may be a BWP in which the terminal performs communication (e.g., transmission and reception operation of a signal and/or channel).

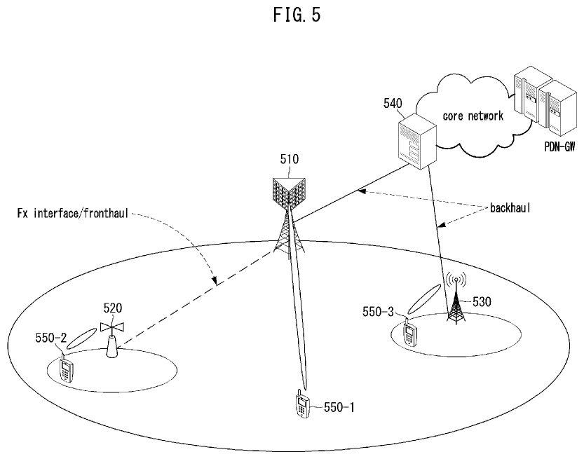

FIG. 5 is a conceptual diagram illustrating exemplary embodiments of a communication network.

Referring to FIG. 5, a communication network may include a core network and an access network. The core network supporting the 4G communication may include an MME, GW (e.g., S-GW, P-GW), and the like. A function block supporting the GW and the MME may be referred to as a GW/MME 540. The core network supporting the 5G communication may include an AMF, UPF, PDN-GW, and the like. A function block supporting the UPF and the AMF may be referred to as a UPF/AMF 540. The access network may include a base station 510, radio access point 520, small base station 530, and terminals 550-1, 550-2, and 550-3. The base station 510 may mean a macro base station. The base station 510 and/or the small base station 530 may be connected to a node (e.g., end node) of the core network through a backhaul. The node (e.g., end node) of the core network may be the GW, UPF, MME, AMF, or the like.

The function split scheme may be applied to the base station 510 and the small base station 530. In this case, each of the base station 510 and the small base station 530 may include one central unit (CU) and one or more distributed units (DUs). The CU may be a logical node that performs functions of an RRC layer, service data application protocol (SDAP) layer, and/or packet data convergence protocol (PDCP) layer. The CU may control operations of one or more DUs. The CU may be connected to an end node of the core network using an SI interface-based backhaul or an NG interface-based backhaul. The SI interface-based backhaul may refer to a backhaul in the 4G communication network, and the NG interface-based backhaul may refer to a backhaul in the 5G communication network.

The DU may be a logical node that performs functions of a radio link control (RLC) layer, MAC layer, and/or PDCP layer. The DU may support one or more cells. The DU may be connected to the CU in a wired or wireless manner using an F1 interface. When a wireless scheme is used, a connection between the DU and the CU may be configured in an integrated access and backhaul (IAB) scheme.

Each of the base station 510 and the small base station 530 may be connected to the radio access point 520 in a wired or wireless manner using an Fx interface (or fronthaul). In the present disclosure, the base station (e.g., macro base station, small base station) may refer to a cell, DU, and/or the like. The radio access point may refer to a transmission and reception point (TRP), remote radio head (RRH), relay, or repeater. The TRP may perform at least one of a downlink transmission function and an uplink reception function. The radio access point 520 may perform only radio frequency (RF) functions.

Alternatively, the radio access point 520 may perform RF functions and some functions of the DU (e.g., some functions of a physical (PHY) layer and/or the MAC layer). Some functions of the DU, which are supported by the radio access point 520, may include lower functions of the PHY layer, functions of the PHY layer, and/or lower functions of the MAC layer. The Fx interface between the base station 510 or 530 and the radio access point 520 may be defined differently depending on the function(s) supported by the radio access point 520.

Each of the radio access point 520 of FIG. 5 and the base stations 110-1, 110-2, 110-3, 120-1, 120-2, 510, and 530 of FIGS. 1 and 5 may support OFDM, OFDMA, SC-FDMA, or NOMA-based downlink communication and/or uplink communication. Each of the radio access point 520 and the base stations 110-1, 110-2, 110-3, 120-1, 120-2, 510, and 530 may support beamforming functions using an antenna array in a transmission carrier of a millimeter wave band. In this case, a service through each beam may be provided without interference between beams within the base station. One beam may provide services for a plurality of terminals.

Each of the radio access point 520 and the plurality of base stations 110-1, 110-2, 110-3, 120-1, 120-2, 510, and 530 may perform MIMO transmission (e.g., single user (SU)-MIMO, multi user (MU)-MIMO, massive MIMO, etc.), coordinated multipoint (COMP) transmission, carrier aggregation (CA) transmission, transmission in an unlicensed band, device-to-device (D2D) communication (or proximity services (ProSe), sidelink communication), and/or the like. Here, each of the plurality of terminals 130-1, 130-2, 130-3, 130-4, 130-5, 130-6, 550-1, 550-2, and 550-3 may perform operations corresponding to operations of the radio access point 520 and/or the plurality of base stations 110-1, 110-2, 110-3, 120-1, 120-2, 510, and 530 and/or operations supported by the radio access point 520 and/or the plurality of base stations 110-1, 110-2, 110-3, 120-1, 120-2, 510, and 530. For example, the second base station 110-2 may transmit a signal to the fourth terminal 130-4 based on the SU-MIMO scheme, and the fourth terminal 130-4 may receive the signal from the second base station 110-2 based on the SU-MIMO scheme. Alternatively, the second base station 110-2 may transmit signals to the fourth terminal 130-4 and the fifth terminal 130-5 based on the MU-MIMO scheme, and each of the fourth terminal 130-4 and the fifth terminal 130-5 may receive the signal from the second base station 110-2 based on the MU-MIMO scheme.

The first base station 110-1, the second base station 110-2, and the third base station 110-3 may transmit a signal to the fourth terminal 130-4 based on the COMP scheme, and the fourth terminal 130-4 may receive the signal from the first base station 110-1, the second base station 110-2, and the third base station 110-3 based on the COMP scheme. Each of the plurality of base stations 110-1, 110-2, 110-3, 120-1, and 120-2 may transmit and receive signals with the terminals 130-1, 130-2, 130-3, 130-4, 130-5, and 130-6 belonging to its own cell coverage based on the CA scheme. Each of the first base station 110-1, the second base station 110-2, and the third base station 110-3 may coordinate D2D communication between the fourth terminal 130-4 and the fifth terminal 130-5, and the fourth terminal 130-4 and the fifth terminal 130-5 may perform the D2D communication according to coordination of the second base station 110-2 and the third base station 110-3, respectively.

Hereinafter, operation methods of a communication node in a communication network will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the communication network, the GW (or, S-GW) may refer to an end communication node of the core network that exchanges packets (e.g., control information, data) with the base station. In the communication network, the MME may refer to a communication node (e.g., entity) in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function of a communication protocol depending on a radio access technology (RAT) or a constituent function of the core network.

In order to perform a mobility support function and a radio resource management function, the base station may transmit a synchronization signal (e.g., synchronization signal/physical broadcast channel (SS/PBCH) block or synchronization signal block (SSB)) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication network is configured, and/or a frame format applied to radio resources in which a synchronization symbol burst capable of identifying a cell in the NR communication network is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the base station 510 may transmit a synchronization signal and/or a reference signal so that a terminal located within its service coverage can discover the base station 510 to perform downlink synchronization maintenance, beam configuration, or link monitoring operations. The terminal 550-1 connected to the base station 510 (e.g., serving base station) may receive physical layer radio resource configuration information for connection configuration and radio resource management from the base station 510.

The physical layer radio resource configuration information may mean configuration parameters included in RRC control messages of the LTE communication network or the NR communication network. For example, the resource configuration information may include PhysicalConfigDedicated, PhysicalCellGroupConfig, PDCCH-Config (Common), PDSCH-Config (Common), PDCCH-ConfigSIBI, ConfigCommon, PUCCH-Config (Common), PUSCH-Config (Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.

● Configuration information of transmission a frequency and a frame format of a base station

▪ Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.

▪ Frame format configuration information: configuration parameters of a mini-slot, slot, and subframe having a different symbol length according to a subcarrier spacing

● Configuration information of a downlink reference signal (e.g., channel state information-reference signal (CSI-RS), common reference signal (Common-RS), etc.)

▪ Configuration parameters such as a transmission periodicity, transmission position, code sequence, or masking (or scrambling) sequence for a reference signal, which are commonly applied within the coverage of the base station (or beam).

● Configuration information of an uplink control signal

▪ Configuration parameters such as a sounding reference signal (SRS), uplink beam sweeping (or beam monitoring) reference signal, uplink grant-free radio resources (or, preambles), etc.

● Configuration information of a physical downlink control channel (e.g., PDCCH)

▪ Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.

● Configuration information of a physical uplink control channel (e.g., PUCCH)

● Scheduling request signal configuration information

● Configuration information for a feedback (acknowledgement (ACK) or negative ACK (NACK)) transmission resource in a hybrid automatic repeat request (HARQ) procedure

● Number of antenna ports, antenna array information, beam configuration or beam index mapping information for application of beamforming techniques

● Configuration information of a downlink signal and/or an uplink signal (or uplink access channel resource) for beam sweeping (or beam monitoring)

● Configuration information of parameters for beam configuration, beam recovery, beam reconfiguration, or radio link re-establishment operation, beam change operation within the same base station, reception signal of a beam triggering handover execution to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the present disclosure, ‘Resource-Config information’ may be a control message including one or more parameters of the physical layer radio resource configuration information. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Config information’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam that can be received. Here, the expression that a communication service is provided through a beam may mean that a packet is transmitted and received through an active beam among one or more configured beams. In the NR communication network, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication network may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, synchronization reconfiguration procedure, or connection reconfiguration procedure, the base station may transmit a dedicated control message including the configuration information of the common reference signal to the terminal.

The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the present disclosure, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), precoding matrix indicator (PMI), HARQ ACK, HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indexes, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The condition (e.g., reference value) indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to-noise ratio (SNR), a signal-to-interference ratio (SIR), a signal-to-interference and noise ratio (SINR), or the like.

Meanwhile, in the NR communication network using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth.

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured condition (e.g., reference value or threshold) and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

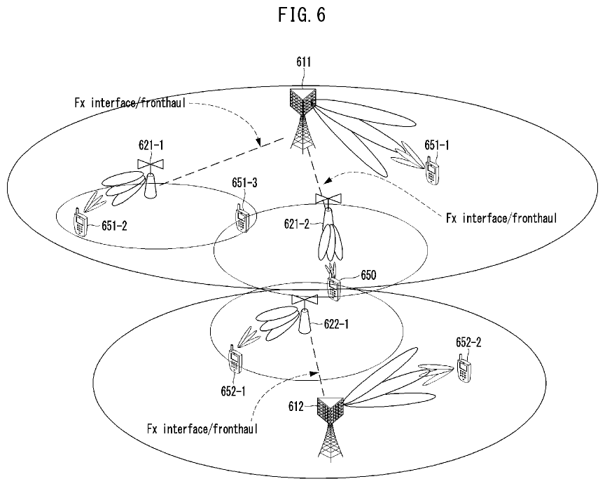

FIG. 6 is a conceptual diagram illustrating exemplary embodiments of a method of providing a service using a plurality of radio access points in a communication network.

Referring to FIG. 6, base stations 611 and 612 may provide services to radio access points 621-1, 621-2, and 622-1 within service coverages through wired interfaces or wireless interfaces. Interfaces between the base station 611 and the radio access points 621-1 and 621-2 within the service coverage of the base station 611 may be provided in a wired or wireless manner. An interface between the base station 612 and the radio access point 622-1 within the service coverage of the base station 612 may be provided in a wired or wireless manner. The function split scheme may be applied to the base stations 611 and 612. In this case, each of the base stations 611 and 612 may be configured as two or more nodes (e.g., CU and DU(s)) that perform radio protocol functions of each of the base stations 611 and 612.

The base stations 611 and 612 and the radio access points 621-1, 621-2, and 622-1 may each provide services to terminals 650, 651-1, 651-2, 651-3, 652-1, and 652-2 within each service coverage through wireless links (e.g., Uu interfaces). Transmission frequencies (or frequency bands) of the radio access points 621-1 and 621-2 within the base station 611 may be the same or different. When the radio access points 621-1 and 621-2 use the same frequency, the radio access points 621-1 and 621-2 may operate as the same cell having the same physical cell ID (PCI) or different cells having different PCIs.

When the radio access points 621-1 and 621-2 operate at the same frequency, the radio access points 621-1 and 621-2 provide a service to the terminal 651-3 in a single frequency network (SFN) scheme. The SFN scheme may refer to a scheme in which one or more radio access points simultaneously transmit the same data to the terminal using the same frequency. In order to provide the SFN scheme-based service, each of the radio access points 621-1 and 621-2 may transmit a downlink channel and/or signal to the terminal 653-1 by using the same resource (e.g., physical resource blocks (PRBs)) in the frequency and time domains. The terminal 653-1 may receive the downlink channel and/or signal from each of the radio access points 621-1 and 621-2 by using a beam (or radio resource) corresponding to a beam identifier (e.g., TCI state identifier) of each of the radio access points 621-1 and 621-2. Here, the expression ‘downlink channel and/or signal’ may refer to at least one of a downlink channel and a downlink signal. The TCI state identifier may refer to a TCI state ID or a TCI state index.

The radio access points 621-1 and 621-2 operating at the same frequency may not use the SFN scheme. In this case, each of the radio access points 621-1 and 621-2 may transmit a downlink channel and/or signal to the terminal 651-3 using a different resource (e.g., PRBs) in the frequency and time domains. The terminal 653-1 may receive the downlink channel and/or signal from each of the radio access points 621-1 and 621-2 by using a beam (or radio resource) corresponding to a beam identifier (e.g., TCI state identifier) of each of the radio access points 621-1 and 621-2.

The radio access points 621-1 and 621-2 may have different PCIs. In other words, the radio access points 621-1 and 621-2 may operate as different cells. The fact that the radio access points 621-1 and 621-2 operate as different cells may mean that the base station 611 includes two or more cells having different PCIs, and each of the radio access points 621-1 and 621-2 is a lower node (or radio access point) of a cell corresponding thereto. Alternatively, the fact that the radio access points 621-1 and 621-2 operate as different cells may mean that two or more cells having different PCIs exist within one DU included in the base station 611 to which the function split scheme is applied, and each of the radio access points 621-1 and 621-2 is a lower node (or radio access point) of a cell corresponding thereto.

When the radio access points 621-1 and 621-2 belong to different cells within a base station or a DU of the base station, a service for a terminal (e.g., terminal in the RRC connected state) that does not support carrier aggregation functions may be provided by one radio access point.

The base station may provide a service to a terminal using one or more cells or one or more radio access points. The base station to which the function split scheme is applied may include one CU and a plurality of DUs, and each of the plurality of DUs may provide a service to a terminal using one or more cells or one or more radio access points.

A control device of the communication network may control operations of network nodes (e.g., base station, cell, radio access point, TRP, etc.) for energy saving (e.g., low-power operations). The radio access point may refer to a TRP. Each of the base station, cell, radio access point, and TRP may be a network node. The control device may control a transmission operation and/or reception operation of the network node. The transmission operation and/or reception operation of the network node may be restricted (e.g., partially restricted) or stopped in a carrier, BWP, physical layer channel, time domain, frequency domain, and/or spatial domain. The control device may adjust a transmission power of the network node. The control device of the communication network may be an entity (e.g., network node) that performs RRC functions of the base station. Alternatively, the control device of the communication network may be a central control node that performs radio resource management (RRM) functions and/or self-organizing networking (SON) functions.

The control device of the communication network may include functional blocks (e.g., functional entities) according to functions to be performed. The functional blocks (e.g., functional entities) may be arranged as being physically separated. The control device may be referred to as a central control unit. The central control unit may mean a central control device. The central control unit (e.g., central control device) may include the component(s) shown in FIG. 2. The central control unit (e.g., central control device) may perform an operation of configuring and/or signaling parameters (e.g., control parameters) required for supporting a forwarding function of traffic (e.g., data) for a data plane, a mobility function for a control plane, and/or a connection control function for the control plane, which are provided through the communication network.

As a method to support a network energy saving (NES) function of a network node, the network node may perform a transmission off operation. The transmission off operation may mean a transmission stop operation. The transmission stop operation may involve halting functions of a transmitting end, RF transmitter, and/or RF chain within the network node. The transmitting end, RF transmitter, and/or RF chain may exist physically. The transmitting end, RF transmitter, and/or RF chain may be configured physically. The transmission stop operation may be performed on a base station, cell, radio access point, frequency (e.g., carrier, transmission carrier), BWP, antenna, and/or transmission beam basis. The transmission stop operation on an antenna basis may be performed depending on the number of MIMO layers, the number of antenna ports, and/or the number of antennas.

The network node may configure parameter(s) for the transmission stop operation, and may transmit control information on the parameter(s) (e.g., parameter configuration) to terminal(s) through signaling. The terminal(s) may be located within a service coverage of the network node. In the present disclosure, signaling may be at least one of SI signaling (e.g., transmission of SIB and/or MIB), RRC signaling (e.g., transmission of RRC parameters and/or higher layer parameters), MAC CE signaling, or PHY signaling (e.g., transmission of DCI, UCI, and/or SCI). Signaling messages may include dedicated control messages.

The control information for the transmission stop operation may include at least one of a frequency (e.g., carrier) of the network node, identifier information of the network node (e.g., identifier of a base station, cell, radio access point, BWP, antenna, and/or transmission beam), information on a time during which the transmission stop operation is applied, information on a start time (e.g., time point) of the transmission stop operation, allocation information of an uplink resource for transmission of feedback information for support of NES function (hereinafter referred to as ‘NES feedback information’), allocation information of an uplink resource for performing an access procedure, or information on a (re) start time (e.g., time point) of transmission of the network node. The network node may be a network node to which the transmission stop operation (e.g., NES operation) is applied.

The transmission stop operation may be performed considering a state (e.g., RRC connected state, RRC inactive state, RRC idle state) of terminal(s) located within the service coverage of the network node and/or a quality of services provided to the terminal(s). If one or more conditions defined in Table 1 below are satisfied, a transmission stop operation may be triggered or performed.

TABLE 1
Condition(s)

Condition 1: A case where the number of terminals in the RRC connected state and/or
terminals in the RRC inactive state within the service coverage meets a preconfigured
threshold
Condition 2: A case where the service quality for terminals in the RRC connected state
within the service coverage meets a preconfigured threshold
Condition 3: A case where the network node indicate a transmission stop operation to
the terminal(s) within the service coverage, or a case where the network node notifies the
terminal(s) within the service coverage that a transmission stop operation is scheduled
Condition 4: A case where there is no reception of NES feedback information from a
terminal and/or there is no access attempt from a terminal before a preconfigured time
expires, after an indication of a transmission stop operation and/or an indication of a
scheduled transmission stop operation is transmitted to terminal(s) within the service
coverage
Condition 5: A case where the network node and/or terminal receives a message (e.g.,
control message) indicating a transmission stop operation from the central control unit

When Condition 1 is configured (e.g., applied), if the number of terminals in the RRC connected state, the number of terminals in the RRC inactive state, or (the number of terminals in the RRC connected state+the number of terminals in the RRC inactive state) satisfies a threshold N that is a preconfigured value, the network node may trigger or perform a transmission stop operation. N may be an integer greater than or equal to 0. For example, Condition 1 may be satisfied if the number of terminals is N or less or if the number of terminals is N or more. The network node's services may be provided to terminals in the RRC connected state and/or terminals in the RRC inactive state. The network node may indicate a terminal to transition to the RRC inactive state, and the terminal may transition to the RRC inactive state.

For example, when Condition 1 is configured to be satisfied if the number of terminals is equal to N, and N is 2, the network node may indicate a terminal in the RRC connected state among two terminals to handover to another cell. Alternatively, the network node may perform a control procedure so that a terminal in the RRC connected state and/or a terminal in the RRC inactive state receives services from another network node. The network node may trigger or perform a transmission stop operation after performing the above-described operation (e.g., handover indication and/or control procedure).

When Condition 1 is configured to be satisfied if the number of terminals is less than N, and N is 1, the network node may trigger or perform a transmission stop operation at a time point (e.g., time) when the network node identifies that the number of terminals in the RRC connected state and/or terminals in the RRC inactive state is 0 or after a preconfigured timer (e.g., transmission stop timer) from the time point expires. The transmission stop timer may mean a transmission stop condition timer. ‘The number of terminals in the RRC connected state and/or the number of terminals in the RRC inactive state is 0’ may refer to ‘there is no terminal in the RRC connected state and/or the RRC inactive state’.

When Condition 2 is configured (e.g., applied), if a quality of services provided to terminal(s) in the RRC connected state does not meet a preconfigured threshold, the network node may trigger or perform a transmission stop operation. The quality of services may be determined based on at least one of a channel quality reported by the terminal(s) (e.g., channel quality measured by the terminal(s)), channel quality measured by the network node based on reference signal(s) transmitted by the terminal(s), frequency (e.g., number) of HARQ retransmissions for the provided services, frequency (e.g., number) of RLC retransmissions, number of radio link failure (RLF) occurrences on a channel, number of beam failure detection (BFD) occurrences, number of beam failure recovery (BFR) occurrences, number of random access failures, or number of physical layer synchronization failures (e.g., number of ‘out of synchronization (OOSs)’).

The channel quality may refer to a quality of a physical layer signal and/or channel in a wireless section. The channel quality may include at least one of a channel state indicator (CSI), received signal strength indicator (RSSI), reference signal received power (RSRP), reference signal received quality (RSRQ), or signal to interference and noise ratio (SINR).

The condition may be configured based on a combination of one or more parameters of service quality. In this case, if parameter(s) reported from the terminal and/or service quality parameter(s) measured by the network node (e.g., calculated service quality) satisfy the condition, the network node may trigger or perform a transmission stop operation. A transmission stop timer that indicates a start of the transmission stop operation may be set. In this case, if the transmission stop timer expires after the above-described condition is satisfied, the network node may perform the transmission stop operation. If a case that the condition becomes not satisfied occurs before the transmission stop timer expires, the transmission stop timer may be stopped or restarted. If the transmission stop timer is stopped, the operation (e.g., procedure) of determining whether Condition 2 is satisfied may be restarted.

When Condition 3 is configured (e.g., applied), if the network node transmits an indication of a transmission stop operation and/or an indication of a scheduled transmission stop operation to the terminal(s) within the service coverage (e.g., terminal(s) in the RRC inactive state and/or terminal(s) in the RRC idle state), the network node may trigger or perform the transmission stop operation. The indication of the transmission stop operation and/or the indication of the scheduled transmission stop operation may be control information. The control information (e.g., the indication of the transmission stop operation and/or the indication of the scheduled transmission stop operation) may be transmitted on a PDCCH and/or PDSCH by using a group scheduling identifier.

The indication of the transmission stop operation and/or the indication of the scheduled transmission stop operation may include at least one of a frequency (e.g., carrier) of the network node, identifier information of the network node (e.g., identifier of a base station, cell, radio access point, BWP, antenna, and/or transmission beam), information on a time during which the transmission stop operation is applied, information on a start time (e.g., time point) of the transmission stop operation, allocation information of an uplink resource for transmission of NES feedback information, allocation information of an uplink resource for performing an access procedure, or information on a (re) start time (e.g., time point) of transmission of the network node. The network node may be a network node to which the transmission stop operation is applied.

One or more scheduling identifiers among various scheduling identifiers (e.g., cell (C)-radio network temporary identifier (RNTI)) may be configure or assigned as scheduling identifier(s) for transmission of the indication of the transmission stop operation and/or the indication of the scheduled transmission stop operation. One or more terminals within the service coverage of the network node may obtain (e.g., receive) the indication of the transmission stop operation and/or the indication of the scheduled transmission stop operation by monitoring group scheduling identifiers.

The control information including the indication of the transmission stop operation and/or the indication of the scheduled transmission stop operation may be transmitted on a PDCCH and/or PDSCH by using a group scheduling identifier. The control information including the indication of the transmission stop operation and/or the indication of the scheduled transmission stop operation may be transmitted to terminal(s) through a paging message transmission procedure using a paging scheduling identifier (e.g., paging (P)-RNTI) and/or a system information transmission procedure (or change notification procedure) using a scheduling identifier (e.g., system information (SI)-RNTI) for system information transmission. To distinguish between the existing paging message, existing SI message, and/or existing SI change notification message and the control information (e.g., message) including the indication of the transmission stop operation and/or the indication of the scheduled transmission stop operation, identification information may be included (e.g., reflected) in the control information. Alternatively, identification information may be included (e.g., reflected) in the existing paging message, existing SI message, and/or existing SI change notification message. The identification information may include at least one of a classification indicator, bearer identifier, logical channel identifier (LCID), header field (e.g., parameter, information element), DCI field (e.g., parameter, information element), or scrambling index.

When the indication of the transmission stop operation and/or the indication of the scheduled transmission stop operation is transmitted on a PDCCH, the indication (e.g., control information) may be included in a DCI in form of a field (e.g., parameter). The DCI including the indication (e.g., control information) may be transmitted to terminal(s). When the indication of the transmission stop operation and/or the indication of the scheduled transmission stop operation is transmitted on a PDSCH, the indication (e.g., control information) may be included in an RRC message and/or MAC CE. The RRC message and/or MAC CE including the indication (e.g., control information) may be transmitted to terminal(s). The MAC CE may be a control message of an MAC layer, which includes including a MAC subheader, MAC header, LCID, MAC protocol data unit (PDU), and/or MAC subPDU.

Condition 4 may be configured (e.g., applied). The terminal may receive the indication of the transmission stop operation and/or the indication of the scheduled transmission stop operation from the network node, and based on the indication, may identify (e.g., recognize) a start of the transmission stop operation and/or a schedule for the transmission stop operation. If there is no reception of NES feedback information from a terminal and/or an access attempt by a terminal from a time at which the start and/or schedule of the transmission stop operation is recognized until a preconfigured timer (e.g., transmission stop timer) expires, the network node may trigger or perform the transmission stop operation. In other words, when Condition 4 is satisfied, the network node may trigger or perform the transmission stop operation.

The terminal may recognize (e.g., identify) that the network node starts the transmission stop operation and/or the transmission stop operation of the network node is scheduled by receiving (e.g., obtaining) system information, indication of the transmission stop operation (e.g., indication of Condition 3), and/or indication of the scheduled transmission stop operation (e.g., indication of Condition 3) from the network node.

In order to indicate the start and/or schedule of the transmission stop operation using system information, the network node may transmit system information (e.g., MIB, SIB1, and/or other SIB) including at least one of an indicator indicating whether the transmission stop operation is supported, indicator indicating whether the transmission stop operation is performed, information indicating a start time of the transmission stop operation, information indicating a time during which the transmission stop operation is applied (e.g., timer information), information indicating a (re) start time of transmission, allocation information of an uplink resource for transmission of NES feedback information (e.g., NES feedback information for Condition 4), or allocation information of an uplink for performing an access procedure (e.g., access procedure for Condition 4).

The terminal may receive the indication of the transmission stop operation and/or indication of the scheduled transmission stop operation according to Condition 3. Based on the indication (e.g., control information), the terminal may recognize (e.g., identify) that the network node starts the transmission stop operation and/or that the transmission stop operation of the network node is scheduled. The control information including the indication of the transmission stop operation and/or indication of the scheduled transmission stop operation may include scheduling information of an uplink resource for transmission of NES feedback information (e.g., NES feedback information for Condition 4) and/or scheduling information of an uplink resource for performing an access procedure (e.g., access procedure for Condition 4).

When Condition 5 is applied (e.g., configured), if a message (e.g., control message) indicating a transmission stop operation is received from the central control unit (e.g., central control device), the network node may trigger or perform the transmission stop operation. The network node may start the transmission stop operation (e.g., a procedure for the transmission stop operation) from a time of receiving the message indicating the transmission stop operation. The network node may start a transmission stop timer at the time of receiving the message indicating the transmission stop operation, and may start the transmission stop operation (e.g., a procedure for the transmission stop operation) when the transmission stop timer expires. The network node may start the transmission stop operation (e.g., a procedure for the transmission stop operation) based on at least one of Condition 1, Condition 2, Condition 3, Condition 4, or Condition 5.

The terminal may receive the indication of the transmission stop operation and/or indication of the scheduled transmission stop operation from the network node, and may use configuration information for the transmission stop operation to perform a random access (RA) procedure, a transmission procedure of a control message (e.g., a control message for service provision), and/or a transmission procedure of data (e.g., data for service provision). The data may refer to packet(s). The RA procedure, control message transmission procedure, and/or data transmission procedure may be performed using the uplink resources allocated for NES feedback information transmission and/or access procedure.

When an RA preamble, RA message, reference signal, L1 control information, L2 control information, control message, and/or data (e.g., packet(s)) is received while the transmission stop operation is performed, the network node may release the transmission stop operation and may (re) start a transmission operation. While the transmission stop operation is performed, the network node may perform a monitoring operation and/or reception operation for the RA procedure (e.g., RA preamble, RA message) for access (e.g., access procedure) of a terminal. The monitoring operation and/or reception operation may be performed continuously at the network node.

The transmission stop operation of the network node may be released (e.g., terminated) by an uplink transmission of a terminal. When the transmission stop operation is released, the network node may transmit information on the release of the transmission stop operation (or information notifying a (re) start of transmission) to terminal(s). The information on the release of the transmission stop operation (or information notifying a (re) start of transmission) may be transmitted in the same and/or similar manner as the indication of the transmission stop operation (e.g., scheduled transmission stop operation). A message for energy saving of the network node (hereinafter referred to as ‘NES control message’) may be transmitted on a PDCCH. An indicator (e.g., indication information) and/or control information related to the NES control message may be included in a DCI in form of field(s) (e.g., parameter(s)), and the DCI may be transmitted to terminal(s). Additionally or alternatively, an NES control message may be transmitted on a PDSCH. An indicator (e.g., indication information) and/or control information related to the NES control message may be transmitted to terminal(s) in form of an RRC message and/or MAC CE. The MAC CE may be a MAC layer control message (e.g., NES control message) including a MAC subheader, MAC header, LCID, MAC PDU, and/or MAC subPDU.

For energy saving in the communication network, the network node may perform NES operations. The NES operations may be performed periodically. The NES operations may include a discontinuous transmission (DTX) operation (e.g., cell DTX operation) and/or a discontinuous reception (DRX) operation (e.g., cell DRX operation).

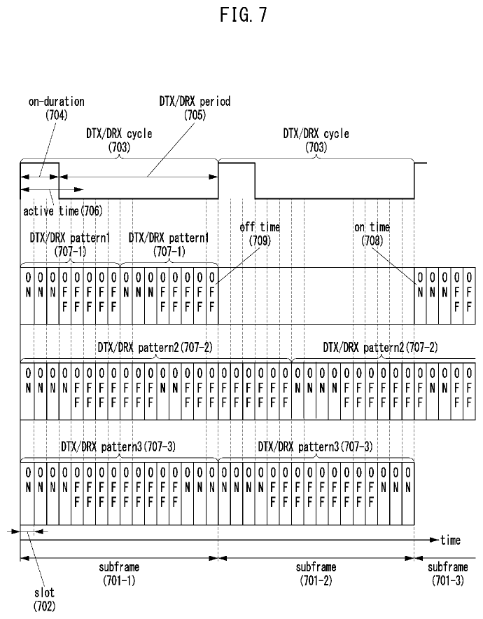

FIG. 7 is a conceptual diagram illustrating exemplary embodiments of DTX/DRX operations in a communication network.

Referring to FIG. 7, a network node may perform a monitoring operation on a channel (e.g., wireless channel) in an on-duration 704 or active time 706 according to a DRX cycle 703. The DRX cycle may mean a DRX periodicity. The DRX cycle may be preconfigured. The active time may mean a DRX active time. The network node may not perform a monitoring operation on a channel in a sleep period or DRX period 705 (e.g., DRX opportunity) within the DRX cycle 703. If a transmission operation and/or reception operation of the network node is not completed within the on-duration, the transmission operation and/or reception operation of the network node may be performed in a period after the on-duration (e.g., a period continuous with the on-duration). A sum of the on-duration and the period after the on-duration may correspond to the active time (e.g., DRX active time).

The DTX operation may be performed in the same and/or similar manner as the DRX operation. The network node may perform a transmission operation on a channel (e.g., wireless channel) in the on-duration 704 or active time 706 according to a DTX cycle 703. The DTX cycle may mean a DTX periodicity. The DTX cycle may be preconfigured. The active time may mean a DTX active time. The network node may not perform a transmission operation and/or reception operation in a sleep period or DTX period 705 (e.g., DTX opportunity) within the DTX cycle 703. If the transmission operation and/or reception operation of the network node is not completed within the on-duration, the transmission operation and/or reception operation of the network node may be performed in a period after the on-duration (e.g., a period continuous with the on-duration). A sum of the on-duration and the period after the on-duration may correspond to the active time (e.g., DTX active time).

DTX/DRX configuration information (e.g., DTX/DRX parameters, DTX/DRX configuration parameters, DTX/DRX information elements) for NES function may be configured. The DTX/DRX configuration information may include DTX configuration information and/or DRX configuration information. The DTX/DRX configuration information may include information on at least one of a DTX cycle, DRX cycle, on-duration, active time, DTX period, or DRX period. The DTX cycle, DRX cycle, on-duration, active time, DTX period, and/or DRX period may be set in units of subframes, slots, mini slots, or symbols. The DTX/DRX cycle 703 may be aligned in one subframe. Alternatively, the DTX/DRX cycle 703 may be set in multiple subframes. The DTX/DRX cycle 703 may not be aligned at a start time and/or end time of a subframe. The DTX/DRX cycle 703 may mean at least one of a DTX cycle or a DRX cycle. In the present disclosure, ‘A/B’ may mean ‘at least one of A or B’.

Depending on a configuration by the central control unit, the DRX operation (e.g., cell DRX operation) and the DTX operation (e.g., cell DTX operation) of the network node may be performed simultaneously according to the same cycle (e.g., the same periodicity). Alternatively, the network node may perform the DRX operation and the DTX operation independently. The DRX operation and the DTX operation may be performed at different times. When the DRX cycle and the DTX cycle are different and/or when a start time of the DRX operation and a start time of the DTX operation are different, the network node may perform the DRX operation and the DTX operation independently. Either the DRX operation or the DTX operation may be configured. The network node may perform either the DRX operation or the DTX operation. In the following exemplary embodiments (e.g., the present disclosure), the DRX operation and the DTX operation may be collectively referred to as ‘DTX operation’. In other words, ‘DTX operation’ may refer to a DTX operation and/or an operation including a DTX operation. The DTX operation may be interpreted as a DTX operation, DRX operation, or ‘DTX operation and DRX operation’ depending on a context.

That a DTX operation is performed may refer to that a DTX operation and a DRX operation are performed together, that a DTX operation and a DRX operation are performed independently, or that either a DTX operation or a DRX operation is performed. The network node may be classified into a transmission-only node and a reception-only node. The transmission-only node may perform a DTX operation. In other words, a DTX operation may be configured in a transmission-only node. The reception-only node may perform a DRX operation. In other words, a DRX operation may be configured in a reception-only node.

To support (e.g., perform) the NES function, a transmitting end, RF transmitter, and/or RF chain of the network node may perform a DTX operation according to a DTX cycle (e.g., DTX periodicity). The transmitting end, RF transmitter, and/or RF chain may exist physically. The transmitting end, RF transmitter, and/or RF chain may be configured physically. The DTX cycle of the network node may be set to equal to or less than the minimum DRX cycle set for a DRX operation of the terminal (e.g., UE DRX operation). The DTX operation may be performed on a base station, cell, radio access point, frequency, carrier (e.g., transmission carrier), BWP, antenna, and/or transmission beam basis. The DTX operation on an antenna basis may be performed depending on the number of MIMO layers, the number of antenna ports, and/or the number of antennas.

Configuration information, control information, and/or parameters for support of DTX operation (e.g., DTX function, DTX operation function) of the network node may be included in system information and/or a control message (e.g., dedicated control message). The system information and/or control message may be an NES control message (e.g., NES message). The base station may transmit an NES control message to a terminal. The terminal may receive the NES control message from the base station and identify the configuration information, control information, and/or parameters for support of DTX operation included in the NES control message.

The control information for support of DTX operation (e.g., NES control message) may include at least one of an indicator indicating whether the DTX operation is supported, indicator indicating whether the DTX operation is performed, information of the DTX cycle, configuration information on the on-duration, information indicating a start time of the DTX operation, information on a timer for performing the DTX operation, uplink resource allocation information (e.g., allocation information of resource(s) configured for reception of uplink signals/channels from the terminal during the DTX operation of the network node), or information indicating a time of releasing the DTX operation.

If one or more DTX operation levels need to be configured, the network node may configure one or more DTX operation levels. The configuration information, control information, and/or parameters included in the NES control message may be configured differently depending on a DTX operation level. A set (e.g., group) may be configured including at least one of the indicator indicating whether the DTX operation is supported, indicator indicating whether the DTX operation is performed, information of the DTX cycle, configuration information on the on-duration, information indicating a start time of the DTX operation, information on a timer for performing the DTX operation, uplink resource allocation information (e.g., allocation information of resource(s) configured for reception of uplink signals/channels from the terminal during the DTX operation of the network node), or information indicating a time of releasing the DTX operation. The set may be an NES control parameter set. A first set for a first DTX operation level (e.g., first NES control parameter set) may be configured, and a second set for a second DTX operation level (e.g., second NES control parameter set) may be configured. The values of parameter(s) included in the first set may be different from the values of the parameter(s) included in the second set.

The network node supporting a plurality of DTX operation levels may generate an NES control message including a plurality of NES control parameter sets, and transmit the NES control message to terminal(s). A terminal may receive the NES control message from the network node and identify the NES control parameter sets for the respective DTX operation levels included in the NES control message. The network node may transmit configuration information for the plurality of DTX operation levels (e.g., configuration information of the NES control parameter set for each DTX operation level) to a plurality of terminals (e.g., all terminals), and may indicate (e.g., configure) a DTX operation level (e.g., NES control parameter set) to be applied to each terminal to the each terminal. Alternatively, the network node may transmit to each terminal an NES message including information indicating a DTX operation level (e.g., NES control parameter set) to be applied to each terminal. When the network node configures a plurality of DTX operation levels, a terminal (e.g., terminal group) may perform an operation according to one DTX operation level.

The network node may transmit the NES control message to terminal(s) in form of an MIB, SIB1, other SIB, and/or dedicated control message. Whether to perform the DTX operation of the network node may be determined to be identically and/or similarly to Condition 1, Condition 2, Condition 3, Condition 4, and/or Condition 5 for transmission stop operation. Whether to perform the DTX operation may be determined based on the number of terminals within the service coverage, service quality, notification of performing the DTX operation, and/or indication of performing the DTX operation. If the network node is determined to perform the DTX operation, the network node may transmit control information and/or an indicator indicating that the DTX operation is performed to the terminal(s) within the service coverage based on the transmission method of the NES control message.

The control information and/or indicator indicating that the DTX operation is performed may be transmitted on a PDCCH and/or PDSCH using a group scheduling identifier. The control information (e.g., indicator) indicating that the DTX operation is performed may include at least one of a frequency (e.g., carrier) of the network node, identifier information of the network node (e.g., identifier of a base station, cell, radio access point, BWP, antenna, and/or transmission beam), information on the DTX cycle, configuration information on the on-duration, information on a start time of the DTX operation, information on a timer for performing the DTX operation, uplink resource allocation information (e.g., information of uplink resource(s) for reception of uplink signals/channels from the terminal during the DTX operation), or information notifying a time of releasing the DTX operation. The network node may be a network node to which the DTX operation is applied.

One or more scheduling identifiers among various scheduling identifiers (e.g., C-RNTI) may be designated or assigned as a scheduling identifier for transmission of control information (e.g., configuration information) of the DTX operation. Terminal(s) within the service coverage of the network node may obtain (e.g., receive) the control information of the DTX operation (e.g., control information and/or indicating that the DTX operation is performed) by monitoring the group scheduling identifier.

The control information of the DTX operation (e.g., control information indicating that the DTX operation is performed) may be transmitted to terminal(s) through a paging message transmission procedure using a paging scheduling identifier (e.g., P-RNTI) and/or a system information transmission procedure (or change notification procedure) using a scheduling identifier (e.g., SI-RNTI) for system information transmission. To distinguish between the existing paging message, existing SI message, and/or existing SI change notification message and the control information of the DTX operation (e.g., control information indicating that the DTX operation is performed), identification information may be included (e.g., reflected) in the control information. Alternatively, identification information may be included (e.g., reflected) in the existing paging message, existing SI message, and/or existing SI change notification message. The identification information may include at least one of a classification indicator, bearer identifier, LCID, header field (e.g., parameter, information element), DCI field (e.g., parameter, information element), or scrambling index.

The network node may perform the DTX operation according to the DTX cycle at a start time of the DTX operation indicated to the terminal. The DTX operation may be performed periodically. If no transmission operation and/or reception operation for a terminal occurs from the start time of the DTX operation until a preconfigured timer (e.g., DTX inactivity timer) expires, the DTX operation of the network node may be started. The network node may start the DTX operation from an on-duration (e.g., DTX on-duration) according to the DTX cycle. Alternatively, the network node may start the DTX operation from a DTX period (e.g., DTX opportunity).

When the DTX operation of the network node is performed, the network node may perform a transmission operation in an on-duration (e.g., DTX on-duration) or an active time including the on-duration (e.g., DTX active time). The terminal may perform a monitoring operation and/or reception operation on a channel (e.g., wireless channel) to receive downlink signals/channels from the network node during the on-duration or active time. When the on-duration or active time ends, the network node may not perform a transmission operation during the DTX period (e.g., DTX opportunity) within the DTX cycle. The terminal may not perform a monitoring operation and/or reception operation for downlink signals/channels of the network node during the DTX period. Alternatively, the terminal may not perform a monitoring operation and/or reception operation for downlink signals/channels of the network node until a start time of the next on-duration.

The network node may transmit minimum signals and/or system information to terminals (e.g., all terminals within the service coverage) in the on-duration or active time. The minimum signals and/or system information may include a synchronization signal, reference signal, MIB, SIB1, and/or other SIBs. The reference signals may be commonly applied to all terminals within the service coverage. The synchronization signal may mean SSB. The synchronization signal may refer to a primary synchronization signal (PSS) and/or a secondary synchronization signal (SSS). The reference signals may be reference signals (e.g., minimum reference signals) for measuring a path loss, measuring a quality of a channel (e.g., wireless channel), selecting a network node, and/or selecting a beam. The reference signals may include at least one of a channel state information-reference signal (CSI-RS), phase tracking (PT)-RS, positioning (P)-RS, or remote interference management (RIM)-RS. The reference signal may be configured UE-specifically. The reference signal may be configured (e.g., allocated) so that it can be received by all terminals within the service coverage. In other words, the reference signal may be commonly configured for all terminals within the service coverage.

The synchronization signal, reference signal, MIB, SIB1, and/or other SIBs may be transmitted within one on-duration. The synchronization signal, reference signal, MIB, SIB1, and/or other SIBs may be distributed or repeatedly transmitted in a plurality of on-durations located within a preconfigured transmission period.

If an RA preamble, RA message, reference signal, L1 control information, L2 control information, control message, and/or data (e.g., packet) is received in the on-duration of the DTX operation, the network node may release the DTX operation. While the DTX operation is performed, the network node may perform a monitoring operation and/or reception operation for an RA procedure (e.g., RA preamble, RA message) for access (e.g., access procedure) of a terminal. The monitoring operation and/or reception operation may be performed continuously at the network node. The monitoring operation and/or reception operation may be performed in the on-duration or active time.

When the DTX operation is released, the network node may transmit information on the release of the DTX operation to the terminal. The information on the release of the DTX operation may be transmitted in the same and/or similar manner as the control information (e.g., indicator) indicating that the DTX operation is performed. The information on the release of the network node may be transmitted in the next on-duration of the DTX operation.

The DTX operation of the network node may be applied together with a DRX operation of the network node. Alternatively, the DTX operation of the network node may be performed independently of the DRX operation of the network node. The network node may perform the NES function by performing the DTX operation and/or DRX operation. The NES operation may be performed based on the DTX/DRX cycle. The network node may perform a transmission operation and/or reception operation based on a DTX pattern, a DRX pattern, and/or a DTX/DRX pattern. Alternatively, the network node may stop the transmission operation and/or reception operation based on the DTX pattern, DRX pattern, and/or DTX/DRX pattern.

In an on-time 708 according to a DTX/DRX pattern 707-1, 707-2, or 707-3 shown in FIG. 7, the network node may perform a transmission operation and/or reception operation. In an off-time 709 according to the DTX/DRX pattern 707-1, 707-2, or 707-3 shown in FIG. 7, the network node may not perform a transmission operation and/or reception operation. The on-time 708 may be an active period. The off-time 709 may be a non-active period. Each of the on-time 708 and off-time 709 may be set in units of subframes, slots, mini slots, or symbols.

The DTX/DRX pattern for supporting the NES function may be configured in units of subframes, similarly to the DTX/DRX pattern 3 707-3 shown in FIG. 7. The DTX/DRX pattern for supporting the NES function may be configured within one subframe, as shown in the DTX/DRX pattern 1 707-1 of FIG. 7. The DTX/DRX pattern for supporting the NES function may be configured in a plurality of subframes, as shown in the DTX/DRX pattern 2 707-2 of FIG. 7.

The DTX/DRX pattern may be applied continuously or discretely in the time domain. A DTX/DRX pattern applied discretely may refer to a DTX/DRX pattern applied discontinuously in the time domain. For example, the DTX/DRX pattern 1 707-1 may be applied to subframes 701-1 and 701-3, and the DTX/DRX pattern 1 707-1 may be applied to a subframe 701-2. Each of the on-time and off-time of the DTX/DRX pattern may be applied continuously or discretely.

When the NES function is applied based on the DTX/DRX pattern, a time region and/or frequency region to which the on-time and/or off-time of the DTX/DRX pattern is not applied and a time region and/or frequency region to which the on-time and/or off-time of the DTX/DRX pattern is applied may be designated (e.g., configured). The time region and/or frequency region to which the DTX/DRX pattern is not applied and the time region and/or frequency region to which the DTX/DRX pattern is applied may be designated (e.g., configuration). Configuration information for the DTX/DRX pattern may include one or more information elements defined in Table 2.

TABLE 2
Information elements (e.g., information)

Information (e.g., indicator) indicating whether the DTX/DRX pattern-based
NES function is supported
DTX pattern information and/or DRX pattern information
Periodicity information of DTX/DRX pattern
Information indicating a start time (e.g., offset) of applying the DTX/DRX pattern
Information indicating a time of releasing (e.g., terminating) application of
the DTX/DRX pattern
Information on a time region and/or frequency region to which the DTX/DRX
pattern is applied
Information on a time region and/or frequency region to which the DTX/DRX
pattern is not applied
Information on a time region and/or frequency region to which the on-time
of the DTX/DRX pattern is applied
Information on a time region and/or frequency region to which the on-time
of the DTX/DRX pattern is not applied
Information on a time region and/or frequency region to which the off-time
of the DTX/DRX pattern is applied
Information on a time region and/or frequency region to which the off-time
of the DTX/DRX pattern is not applied

The information elements (e.g., configuration information) defined in Table 2 may be configured using a unit representing a time region and/or frequency region. The time region may be configured in units of frames, subframes, slots, mini-slots, and/or symbols. The frequency region may be configured in units of a carrier (e.g., transmission carrier), transmission frequency, BWP, subchannel, physical resource block (PRB), RB set, and/or subcarrier.

The network node may transmit configuration information of the DTX/DRX pattern to terminal(s) using system information and/or a control message (e.g., dedicated control message). Alternatively, the configuration information of the DTX/DRX pattern may be included in an NES control message, and the NES control message may be transmitted to terminal(s). In order to inform the configuration information of the DTX/DRX pattern using system information, the network node may transmit at least part of the configuration information of the DTX/DRX pattern to terminal(s) in form of an MIB, SIB1, other SIB, and/or dedicated control message.

A terminal may obtain (e.g., receive) the configuration information of the DTX/DRX pattern from the network node. The terminal may identify the on-time and/or off-time based on the configuration information of the DTX/DRX pattern. The terminal may perform a transmission operation and/or reception operation in the on-time of the DTX/DRX pattern. The terminal may not perform a transmission and/or reception operation in the off-time of the DTX/DRX pattern. A terminal in the RRC connected state may receive services from the network node that supports the DTX/DRX pattern-based NES function. A terminal in the RRC inactive state may camp on the network node that supports the DTX/DRX pattern-based NES function. The DTX/DRX pattern-based NES function may mean the DTX/DRX-based NES operation.

A terminal in the RRC connected state, terminal in the RRC inactive state, and/or terminal in the RRC idle state may not perform a monitoring operation, reception operation, and/or measurement operation on downlink signals/channels of the network node in the off-time of the DTX/DRX pattern. A terminal in the RRC connected state, terminal in the RRC inactive state, and/or terminal in the RRC idle state may not perform an uplink signal/channel transmission operation in the off-time of the DTX/DRX pattern. A terminal in the RRC connected state, terminal in the RRC inactive state, and/or terminal in the RRC idle state may perform a monitoring operation, reception operation, and/or measurement operation on downlink signals/channels of the network node in the on-time of the DTX/DRX pattern (or a time region and/or frequency region to which the DTX/DRX pattern is not applied). A terminal in the RRC connected state, terminal in the RRC inactive state, and/or terminal in the RRC idle state may perform an uplink signal/channel transmission operation in the on-time of the DTX/DRX pattern (or a time region and/or frequency region to which the DTX/DRX pattern is not applied).

The network node performing the DTX/DRX-based NES operation may not configure uplink resource(s) (e.g., uplink resource region) for transmission of an RA message (e.g., RA preamble) and/or NES feedback information for requesting to stop the NES operation in the off-time of the DTX/DRX pattern. In other words, the uplink resource(s) for transmission of the RA message (e.g., RA preamble) and/or NES feedback information requesting to stop the NES operation may be excluded in the off-time of the DTX/DRX pattern. Alternatively, transmission of the RA message (e.g., RA preamble) and/or NES feedback information for requesting to stop the NES operation may be allowed in the off-time of the DTX/DRX pattern.

To minimize the impact of the DTX/DRX-based NES operation on the existing terminals (e.g., legacy terminals), a time division duplex (TDD) type slot format may be used. The existing terminals may not support NES operations. A terminal that does not support the NES operation may be referred to as a non-NES terminal. A terminal that supports the NES operation may be referred to as an NES terminal. A slot format for a TDD system may be configured in units of slot(s) and/or symbol(s) constituting a subframe. A type (e.g., format) of a slot and/or a symbol may be classified as downlink (D), uplink (U), and/or flexible (F). D (or DL) may indicate a downlink slot and/or a downlink symbol. U (or UL) may indicate an uplink slot and/or an uplink symbol. F (or FL) may indicate a flexible slot and/or flexible symbol. The flexible slot may be configured as a downlink slot or uplink slot according to configuration and/or scheduling (e.g., resource allocation) by the network node. The flexible symbol may be configured as a downlink symbol or uplink symbol according to configuration and/or scheduling (e.g., resource allocation) by the network node.

The network node may configure a slot and/or symbol corresponding to the-off time of the DTX/DRX pattern as an F slot and/or symbol in a TDD slot format of the existing terminal (e.g., legacy terminal). The network node may not perform scheduling (e.g., resource allocation) for a transmission operation and/or reception operation of a terminal in the slot and/or symbol configured as the F slot and/or symbol in the existing terminal. The network node may not configure a reference signal for a measurement operation and/or monitoring operation of a terminal in the slot and/or symbol configured as the F slot and/or symbol in the existing terminal. According to the above-described method, the impact of the DTX/DRX-based NES operation on the existing terminals can be excluded or minimized.

In order to exclude or minimize the impact of the DTX/DRX-based NES operation on the existing terminal, a method for the network node performing the NES operation to control a camping procedure and/or operation of the existing terminal in the RRC idle state may be required

<In Case that the Existing Terminal in the RRC Idle State is Allowed to Camp on a Network Node Performing NES Operations>

A terminal in the RRC idle state may perform a cell (re) selection procedure, select a network node performing NES operation in the cell (re) selection procedure, and camp on the selected network node. The cell (re) selection procedure may mean a cell selection procedure and/or a cell reselection procedure. An existing terminal may perform an RA procedure to access the network node performing NES operations (e.g., network node supporting the NES function). The existing terminal may request connection establishment from the network node by performing the RA procedure. A terminal that supports the NES function (e.g., terminal in the RRC idle state) may transmit, to the network node, an RA message, MAC CE, and/or RRC message including information (e.g., indicator, field, parameter) indicating whether the terminal supports the NES function in an RRC connection establishment procedure. The information indicating whether the terminal supports the NES function may be included in an RRC connection establishment request message, and the RRC connection establishment request message may be transmitted to the network node.

The network node performing NES operations (e.g., network node supporting the NES function) may receive the RRC connection establishment request message from the terminal in the RRC idle state. While performing the RRC connection establishment procedure or after completing the RRC connection establishment procedure, the network node may indicate the terminal to perform a handover or redirection to another network node. To support the above-described operation, the network node may transmit a message (e.g., RRC message, MAC CE, MAC control message) indicating the handover (e.g., switching) to another network node while performing the RRC connection establishment procedure or after completing the RRC connection establishment procedure. Alternatively, the network node may transmit a control message indicating redirection by using an RRC connection reject message.

The message indicating the handover (e.g., switching) may include information on a network node that is a target of the handover (e.g., switching). The message indicating the redirection may include information on a network node that is a target of the redirection. The information on the network node may be information on a network node to which the terminal is to perform a new access procedure. The information on the network node may include at least one of RAT-type identification information, cell identifier, TRP identifier, carrier identifier, frequency identifier, beam configuration information, beam identifier, access priority information, network node priority information, uplink resource allocation information, or contention free RA (CFRA) resource information.

The network node may selectively transmit the indication of the handover (e.g., switching) or redirection to another network to the existing terminal and/or terminal not supporting the NES function, based on the control message (e.g., control message including information indicating whether or not the NES function is supported). The existing terminal and/or terminal not supporting the NES function may be referred to as a non-NES terminal. In other words, the non-NES terminals may include the existing terminals and/or terminals that do not support the NES function.

The network node performing NES operations (e.g., network node supporting the NES function) may transmit information on a time resource and/or frequency resource through which a terminal in RRC idle state is allowed to access. The information on the time resource and/or frequency resource through which access is allowed may be referred to as ‘access permission information’. The access permission information may indicate a time and/or frequency resource corresponding to the next on-time (e.g., active period) according to the NES operation. The network node may transmit the access permission information using system information. The access permission information may be transmitted to terminal(s) in the RRC idle state. The access permission information may indicate the time resource and/or frequency resource through which a terminal in the RRC idle state can perform an access procedure to the network node. The access permission information may indicate a time resource and/or frequency resource through which a terminal in the RRC idle state can receive a downlink signal/channel. The time resource and/or frequency resource indicated by the access permission information may correspond to the next on-time (e.g., active period).

The RRC idle state terminal camping on the network node performing NES operations (e.g., network node supporting the NES function) may identify information on the next on-time (e.g., active period) based on the system information received from the network node. The RRC idle state terminal may receive a downlink signal/channel in the next on-time (e.g., time resource and/or frequency resource) indicated by the system information. Alternatively, the RRC idle state terminal may perform an access procedure to the network node in the next on-time (e.g., time and/or frequency resource) indicated by the system information.

<In Case that the Existing Terminal in the RRC Idle State is not Allowed to Camp on a Network Node Performing NES Operations>

In order to restrict a non-NES terminal from performing a camping and/or access operation to the NES node, a cell bar procedure may be applied. The NES node (e.g., NES network node) may refer to a network node that supports the NES function and/or a network node that performs NES operations. The NES node transmits system information (e.g., MIB, SIB1, and/or other SIB) including cell bar indication information to terminals (e.g., NES terminal(s) and/or non-NES terminal(s)). A non-NES terminal may receive the system information from the NES node, may identify the cell bar indication information included in the system information, and may not perform a camping operation and/or access operation to the NES node based on the cell bar indication information. The cell bar indication information may indicate whether an NES terminal is allowed to perform an access procedure to the network node (e.g., NES node).

If an NES terminal is allowed to perform an access procedure to a network NES node, an access procedure between the NES terminal and the network NES node may be performed. Even when an NES terminal is allowed to perform an access procedure to the network NES node, an access procedure between a non-NES terminal and the network NES node may not be performed. In other words, an access procedure between a non-NES terminal and the network NES node may be restricted. If an NES terminal is not allowed to perform an access procedure to the network NES node (e.g., if the network NES node also indicates a cell bar to the NES terminal), an access procedure between the NES terminal and the network NES node may not be performed. The network NES node may refer to an NES node or a NES network node.

Even when cell bar indication information (e.g., system information including cell bar indication information for non-NES terminals) is received, an NES terminal may perform a camping operation and/or access operation to the NES node. The NES terminal may identify that the network node is an NES node based on information indicating whether the NES operation is supported and/or information indicating whether the NES operation is performed, which is included in system information and/or control message. If the network node transmitting the cell bar indication information for non-NES terminals is an NES node, an NES terminal may perform a camping operation and/or access operation to the NES node.

In order to restrict non-NES terminals from performing a camping operation and/or access operation to the NES node, a blacklist and/or NES node list may be used. The network node may transmit the blacklist and/or NES node list to terminal(s). The blacklist and/or NES node list may restrict non-NES terminals from performing a camping operation and/or access operation to the NES node. The blacklist may include information of network node(s). The camping operation and/or access operation to network node(s) (e.g., NES node(s)) indicated by the blacklist may not be performed by terminals in the RRC idle state and/or non-NES terminals. The NES node list may include information on network node(s) to identify NES node(s).

When a terminal transitions to the RRC idle state and/or the RRC inactive state, the network node may transmit a message (e.g., RRC connection reconfiguration message, RRC connection release message, dedicated control message) including the blacklist and/or NES node list. The blacklist and/or NES node list may indicate network node(s) (e.g., NES node(s)) to which a camping operation and/or access operation (e.g., access procedure) of terminal(s) is restricted. A terminal may receive the blacklist and/or NES node list for the network node and/or adjacent network node(s) (e.g., adjacent cell(s)) from the network node. The blacklist and/or NES node list may be included in system information and/or RRC message.

A non-NES terminal may receive the blacklist and/or NES node list from the network node. The non-NES terminal may not camp on the NES node. The non-NES terminal may not perform an access procedure to the NES node.

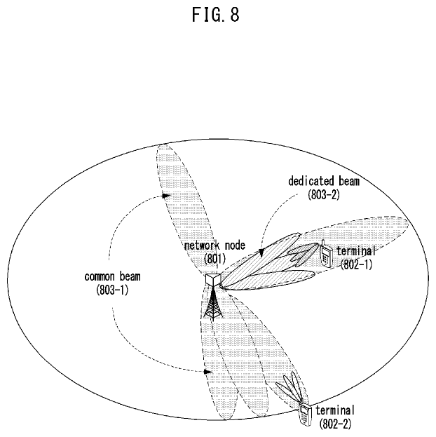

FIG. 8 is a conceptual diagram illustrating exemplary embodiments of a method for configuring a hierarchical beam for NES in a communication network.

Referring to FIG. 8, hierarchical beam configuration may include a common beam 803-1 and a dedicated beam 803-2. The common beam 803-1 may cover a service coverage of a network node 801. The dedicated beam 803-2 may be configured on a terminal (or terminal group) basis. The dedicated beam 803-2 may be referred to as a hierarchical beam.

The network node 801 may provide services to a terminal 802-2 located at a boundary of the service coverage using the common beam 803-1. The network node 801 may use the dedicated beam 803-2 to provide services to terminals located in a central region and/or within the service coverage of the network node 801. The common beam 803-1 may be a beam for SSB (e.g., SS/PBCH block) transmission. Alternatively, the common beam 803-1 may be a beam associated (e.g., mapped) with a beam for SSB transmission. The dedicated beam 803-2 may be allocated (e.g., configured) to a terminal located in the central region and/or within the service coverage of the network node 801.

The dedicated beam 803-2 may be allocated (e.g., configured) to a terminal that satisfies a preconfigured condition for channel quality (e.g., RSSI, RSRP, RSRQ, and/or CSI). The preconfigured condition (e.g., operating condition of the dedicated beam) may mean a value (e.g., threshold) set based on a measurement and/or estimation result of channel quality parameter(s). The operating condition of the dedicated beam may be configured as a timer (e.g., condition value in the time domain) and/or a threshold (e.g., condition value) for channel quality. The operating condition of the dedicated beam may be transmitted to the terminal according to the transmission method of the NES message (e.g., NES control message).

The NES node may provide services to a terminal that satisfies the operating condition of the dedicated beam by using the dedicated beam. The terminal that satisfies the operating condition of the dedicated beam may be a terminal that has a measurement and/or estimation result for channel quality parameter(s) satisfying the operating condition of the dedicated beam. If there is no terminal that satisfies the operating condition of the dedicated beam, the network node (e.g., NES node) may not perform a transmission operation and/or reception operation using the dedicated beam until a terminal that satisfies the operating condition of the dedicated beam appears. In other words, if a terminal that satisfies the operating condition of the dedicated beam is not recognized, the network node (e.g., NES node) may not perform communication using the dedicated beam. According to the above-described operation, energy of the network node (e.g., NES node) can be saved.

If a preconfigured NES condition is satisfied, the NES node may provide services to terminals within the service coverage by using the common beam. The NES condition may be a condition for the number of terminals to which the NES node provides services and/or a load status of the NES node. The NES condition may be informed to terminals based on the transmission method of the NES message. In other words, the network node (e.g., NES node) may transmit an NES message including the NES condition to the terminals. The NES node may perform (e.g., apply) both the DTX/DRX-based NES function and/or the hierarchical beam-based NES function based on the load status of the network node and/or the status of terminal(s).

The common beam and/or dedicated beam may be configured or mapped to each BWP configured by the network node. The NES node may always use the common beam.

Alternatively, the NES node may use the common beam more frequently than the dedicated beam. For example, an on-time (e.g., active period) for the DTX/DRX operation may be configured to be long, and an off-time (e.g., non-active period) for the DTX/DRX operation may be configured to be short. The NES node may configure one or more dedicated beams. The NES node may allocate (e.g., configure) one or more dedicated beams to a terminal in the RRC connected state.

The NES node may not transmit a reference signal in an off-time (e.g., non-active period) for the common beam and/or dedicated beam. In other words, the NES node may not transmit a reference signal using the common beam and/or dedicated beam in the off-time (e.g., non-active period). A reference signal may not be transmitted in a frequency region (e.g., radio resource) in which the common beam and/or dedicated beam is not configured (e.g., allocated).

A terminal may obtain information on NES operations based on an indicator indicating whether the NES operation is supported (e.g., performed). The indicator indicating whether the NES operation is supported (e.g., performed) may be included in system information (e.g., MIB, SIB1, and/or other SIB) and/or control message (e.g., dedicated control message), and the system information and/or control message may be transmitted to the terminal. The indicator indicating whether the NES operation is supported (e.g., performed) may indicate whether the network node is a booster node. The indicator indicating whether the NES operation is supported (e.g., performed) may indicate whether the network node applies the NES operation.

The terminal may determine a priority of a cell (re) selection procedure for the network node and/or whether to perform a measurement/reporting procedure for the network node based on the indicator indicating whether the NES operation is supported (e.g., performed). For example, the terminal may set the priority of the cell (re) selection procedure for the network node to be low. The terminal may restrict the measurement/reporting procedure for the network node. The booster node may refer to a node installed for service coverage expansion. The booster node may refer to a node that performs functions of a secondary network node. For example, when services are provided to a terminal through a plurality of network nodes based on a function of multiple radio access points, carrier aggregation (CA) function, and/or a dual connectivity (DC) function, a node performing functions of a secondary network node may be a booster node.

The booster nodes may be classified into a downlink-only node and an uplink-only node. The downlink-only node may perform downlink communication for the terminal and may not perform a reception operation of uplink signals/channels. The uplink-only node may perform a reception operation of uplink signals/channels and may not perform downlink communication for the terminal. The uplink-only node may perform a transmission operation of downlink signals/channels (e.g., MIB, PSS, SSS, and/or PBCH) to acquire and/or maintain physical layer synchronization.

A process for an NES operation may be designated (e.g., configured). A process (e.g., process identifier) for a transmission stop operation and/or DTX/DRX operation may be configured, and control parameters for the process may be configured. When an NES operation is configured on a process basis, a process (e.g., process identifier) may be dedicated (e.g., configured) for each unit for the NES operation (e.g., base station, cell, radio access point, BWP, frequency, carrier (e.g., transmission carrier), antenna (e.g., number of MIMO layers, number of antenna ports, and/or number of antennas), and/or beam (e.g., transmission beam). One or more processes may be designated (e.g., configured) for each of a transmission stop operation and a DTX/DRX operation.

When a process for an NES operation is designated, control information and/or indicator for the NES operation may include a process identifier to identify the process of the NES operation. A process identifier associated with (e.g., mapped to) the process of the NES operation may be configured.

When the process identifier for the NES operation is configured, the terminal may use the process identifier to obtain or distinguish a control message for the NES operation. When the process and/or process identifier of the NES operation is configured, the NES control message (e.g., NES message) may further include the process identifier of the NES operation. For example, the NES control message may include the control information (e.g., indicator) and/or the process identifier for the NES operation.

The terminal may receive the process identifier from the network node, and the terminal may identify, based on the process identifier, an indication of performing the NES operation (e.g., activation of the NES operation), indication of stopping the NES operation (e.g., deactivation of the NES operation), indication of releasing the NES operation (e.g., deactivation of the NES operation), and/or control parameter(s) configured for the process.

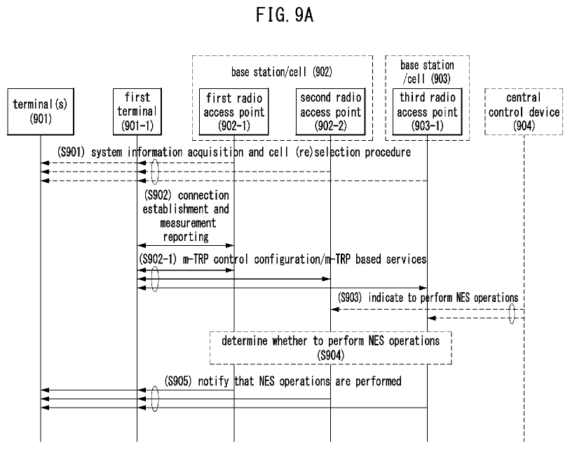

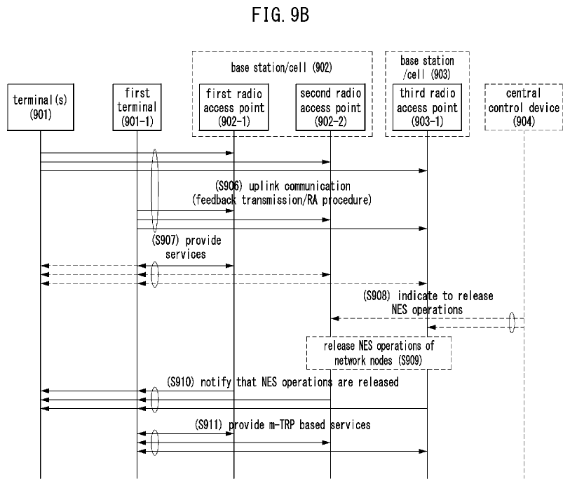

FIGS. 9A and 9B are sequence charts illustrating exemplary embodiments of an NES operation.

Referring to FIGS. 9A and 9B, an NES operation may be performed in an environment (e.g., communications network) that includes multiple radio access points. Each of a base station, cell, and radio access point (e.g., TRP) may be a network node. A first radio access point 902-1 and a second radio access point 902-2 may belong to a base station (e.g., cell) 901. The first radio access point 902-1 and the second radio access point 902-2 may belong to the same cell controlled by an RRC function of the base station 902. Alternatively, the first radio access point 902-1 and the second radio access point 902-2 may belong to different cells. The network nodes may correspond to cells belonging to different base stations 902 and 903. For example, the first base station 902 may refer to a first network node, and the second base station 903 may refer to a second network node. Each of the base stations 902 and 903 may perform an independent RRC function. When the first network node 902 and the second network node 903 correspond to cells belonging to the same base station, the first network node 902 and the second network node 903 may be controlled by one RRC function (e.g., one RRC entity).

A terminal(s) 901 may operate in the RRC inactive state or the RRC idle state. In step S901, the terminal(s) 901 may receive system information from the radio access points 902-1, 902-2, and/or 903-1 belonging to the base stations 902 and 903, perform a measurement operation based on the system information, and perform a cell (re) selection procedure based on results of the measurement operation. In step S901, the terminal(s) 901 may select an optimal cell 902 by performing the cell (re) selection procedure and camp on the selected optimal cell 902. In step S901, the terminal(s) 901 in the RRC inactive state or RRC idle state may obtain control information for NES operations.

In step S902, a first terminal 901-1 among the terminal(s) 901 may perform an RA procedure to the first radio access point 902-1 belonging to the cell 902, and may establish an RRC connection with the base station 902 based on the RA procedure. The cell 902 may be a cell on which the first terminal 901-1 camps. Once the RRC connection is established, the operation state of the first terminal 901-1 may transition to the RRC connected state. In step S902, the first terminal 901-1 may receive services through the first radio access point 902-1 based on connection configuration parameters. In step S902, the first terminal 901-1 may report a measurement result of service quality according to Condition 2 (e.g., Condition 2 defined in Table 1) to the first radio access point 902-1.

In step S902-1, the first terminal 901-1 may receive configuration information of control parameters for supporting a function using one or more radio access points 902-1, 902-2, and 903-1. In step S902-1, the first terminal 901-1 may receive services based on the multiple radio access points. Step S902-1 may be performed based on a signaling operation in step S902 and/or an additional signaling operation after step S902.

The one or more radio access points 902-1, 902-2, and 903-1 may provide services to the first terminal 901-1. In step S903, the central control unit (e.g., central control device) 904 may transmit information indicating to perform the NES operation to the second radio access point 902-2 and the third radio access point 903-1. Alternatively, step S904 may be performed instead of step S903. In step S904, an entity and/or protocol layer responsible for the NES operation (e.g., NES function) in each of the network nodes (e.g., base stations, cells, radio access points) may determine, decide, and/or indicate whether to perform the NES operation.

When a process for the NES operation is configured, whether to perform the NES operation may be determined, decided, and/or indicated on a process basis in step S904. When a CA function using a primary cell (PCell) 902 and a secondary cell (SCell) 903 is configured in the terminal(s) 901, a primary radio access point (e.g., the first radio access point 902-1) among radio access points belonging to the primary cell or a radio access point (e.g., the first radio access point 902-1), which is determined by the primary cell based on a service quality condition according to a measurement result of terminal(s) and/or NES operation (e.g., NES method), may not perform the NES operation.

The base stations 902 and 903 may determine whether the NES operations of the radio access points 902-1, 902-2, and 903-1 are performed. In this case, the base stations 902 and 903 may transmit control messages indicating the radio access points 902-2 and 903-1 to perform the NES operations to the radio access points 902-2 and 903-1 determined to perform the NES operations. The base stations 902 and 903 may change or set values of parameters related to the NES operations. Whether to perform the NES operations for the radio access points 902-1, 902-2, and 903-1 may be determined based on a result of step S903, a result of step S904, and/or preconfigured condition (e.g., preconfigured parameters). In step S905, the network node may indicate (e.g., notify) to the terminal(s) 901 and 901-1 within the service coverage that the NES operation is performed. The indication to perform the NES operation may mean activation indication of the NES operation. The activation indication of the NES operation may be transmitted through an RRC signaling message and/or an L1 message (e.g., DCI, L1 group common signaling message). In step S905, the NES control message notifying that the NES operation is performed may include the process identifier of the NES operation. In step S905, control information, process identifier, and/or indicator for the NES operation of each of the second radio access point 902-2 and the third radio access point 903-1 may be transmitted to the terminal(s) 901 and 901-1.

The NES control message transmitted to the terminal(s) 901 and 901-1 in step S905 may be an RRC message (e.g., RRC control message), MAC message (e.g., MAC CE), and/or PHY message (e.g., DCI, field(s) within DCI, parameter(s) within DCI). When the NES control message is a MAC CE, a MAC header and/or LCID to identify the MAC CE may be configured separately. The MAC CE (e.g., NES control message) may include at least one of identifier information (e.g., identifier of a base station, cell, radio access point, BWP, frequency, carrier, antenna, and/or transmission beam), process identifier for the NES operation, allocation information of an uplink resource for NES feedback information transmission, allocation information of an uplink resource for performing an access procedure, timer information, periodicity (e.g., cycle) information of the NES operation, or identification information for identifying a service to which the NES operation is applied.

The identifier information included in the MAC CE (e.g., identifier of a base station, cell, radio access point, BWP, frequency, carrier, antenna, and/or transmission beam) may be used to identify a target for which the NES operation is not performed (e.g., target to which the NES operation is not applied). In this case, the terminal(s) 901 and 901-1 may distinguish between network nodes for which NES operations are performed and network nodes for which NES operations are not performed based on the information included in the MAC CE.

Through the signaling operation in step S905 and/or a separate signaling operation before step S906, the network node (e.g., base station, cell, radio access point) may transmit control information indicating to release, disable, or suspend a semi-persistent scheduling (SPS) allocation of downlink resources configured in the terminal(s) 901 and 901-1 and/or a configured grant (CG) allocation of uplink resources configured in the terminal(s) 901 and 901-1. The control information indicating to release, disable, or suspend of the resources allocated in the SPS and/or CG scheme may be transmitted to the terminals 901 and 901-1 through at least one of an RRC control message, MAC CE, or DCI (e.g., field(s) and/or parameter(s) in DCI). The control information may include information (e.g., identification information) indicating the resources allocated in the SPS and/or CG scheme, which are subject to the release, disable, or suspension.

The terminal(s) 901 and 901-1 may receive a control message indicating to release, disable, or suspend the resources allocated in the SPS and/or CG scheme. The terminal(s) 901 and 901-1 may deactivate or stop a monitoring operation and/or reception operation for SPS resources based on the control message. The terminal(s) 901 and 901-1 may deactivate or stop a transmission operation for CG resources based on the control message. The terminal(s) 901 and 901-1 may release the configured SPS resources and/or CG resources.

Through the signaling operation in step S905 and/or a separate signaling operation before step S906, the network node (e.g., base station, cell, radio access point, TRP) may transmit control information indicating to perform a DRX operation and/or a go-to-sleep (GTS) operation to the terminal(s) 901 and 901-1 by using an RRC message, MAC CE, and/or DCI (e.g., field(s) and/or parameter(s) within DCI). If it is determined in step S903 and/or S904 that the radio access point is to perform the NES operation, the network node (e.g., base station, cell, radio access point, TRP) may transmit the control information indicating to perform the DRX operation and/or GTS operation to the terminal(s) 901 and 901-1 within the service coverage before performing the NES operation.

Parameters (e.g., periodicity, cycle, and/or timer) for the DRX operation and/or GTS operation may be set to be aligned with parameters for the NES operation. Alternatively, the parameters (e.g., periodicity, cycle, and/or timer) for the DRX operation and/or GTS operation may be set to have a specific relationship with the parameters for the NES operation. In this case, the terminal(s) 901 and 901-1 may perform the NES operation based on the DRX operation and/or GTS operation according to the parameters for the DRX operation and/or GTS operation without performing step S906.

In S905, the terminal(s) 901 in the RRC connected state may receive the control message for NES operation. If service provision from the second radio access point 902-2 and/or third radio access point 903-1 is required, the terminal(s) 901 may perform a transmission procedure of NES feedback information or an RA procedure (e.g., access procedure) before a transmission stop timer (e.g., transmission stop start timer, transmission stop condition timer) or a DTX inactivity timer expires.

After step S905, the network node (e.g., base station, cell, radio access point, TRP) performing the NES operation may perform a monitoring operation and/or a reception operation on uplink resources. The uplink resources may include the uplink resource allocated for NES feedback information transmission, uplink resource allocated for an access procedure (e.g., RA procedure), and/or uplink resource configured for reception during the DTX operation. The network node may receive an RA message (e.g., RA preamble) and/or NES feedback information requesting to stop the NES operation by performing a monitoring operation and/or reception operation on the uplink resources.

After step S905 (e.g., in step S906), the first terminal 901-1 in the RRC inactive state or RRC idle state and/or the terminal(s) 901 in the RRC connected state that do not receive scheduling of an uplink resource may perform a transmission procedure of NES feedback information or an RA procedure (e.g., access procedure) by using an uplink resource indicated by control information (e.g., uplink resource allocation information for NES feedback information transmission and/or access procedure) for a transmission stop operation obtained through step S901 or step S905 and/or a connection release message (e.g., RRC release message), an uplink resource indicated by control information for the DTX operation (e.g., allocation information of uplink resource(s) for reception from the terminal during the DTX operation), and/or an uplink resource allocated for an RA procedure.

In step S906, the terminal(s) 901 and 901-1 may transmit a process identifier of an NES operation to indicate a preference for performing the NES operation associated with a process having the process identifier. For example, depending on a configuration of the system, the process identifier transmitted by the terminal may explicitly or implicitly indicate the terminal's preference or NES feedback information on whether the terminal prefers to perform or exclude the NES operation corresponding to the process having the process identifier.

After step S905, the radio access point(s) 902-1, 902-2 and 903-1 may receive NES feedback information for the NES operation or an RA message (e.g., RA preamble) for an RA procedure from the terminal(s) 901 and 901-1. In this case, the radio access point(s) 902-1, 902-2, and 903-1 may not perform the NES operations. The network node(s) (e.g., radio access point(s)) that do not perform the NES operations may perform step S909 without performing step S907.

The second radio access point 902-2 and/or third radio access point 903-1 may support multiple radio access point-based services. The second radio access point 902-2 and/or third radio access point 903-1 may notify the terminal(s) 901 and 901-1 that the NES operation is performed. When information indicating that the NES operation is performed is received from the second radio access point 902-2 and/or third radio access point 903-1, the terminal(s) 901 and 901-1 may receive services from the first radio access point 902-1 that does not perform the NES operation (S907). In other words, in step S907, the first radio access point 902-1 which does not perform the NES operation may provide services to the terminal(s) 901 and 901-1. In step S907, the second radio access point 902-2 and/or third radio access point 903-1 performing the NES operations may provide restricted services to the terminal(s) 901 and 901-1.

The second radio access point 902-2 and/or third radio access point 903-1 may perform a transmission stop operation and/or DTX operation on a base station, cell, radio access point, BWP, frequency, carrier, antenna, and/or transmission beam basis. Therefore, services provided by the second radio access point 902-2 and/or third radio access point 903-1 to the terminal(s) 901 and 901-1 may be restricted on a base station, cell, radio access point, BWP, frequency, carrier, antenna and/or transmission beam basis. The terminal(s) 901 and 901-1 may perform a monitoring operation, transmission operation, and/or reception operation for channels in an on-duration and/or active time according to the DTX operation. For a base station, cell, radio access point, BWP, frequency, carrier, antenna, and/or transmission beam to which the transmission stop operation is not applied, the terminal(s) 901 and 901-1 may perform a monitoring operation, transmission operation, and/or reception operation for channels.

In order to support the multiple radio access point-based function configured in the terminal in step S907, the operating conditions and/or parameters may not be released. In step S907, service provision using a DTX period according to the NES operation (e.g., DTX operation) and/or resources (e.g., channel) to which a transmission stop operation of the network node is applied may be stopped. The terminal(s) 901 and 901-1 may not perform a monitoring operation, transmission operation, reception operation, and/or measurement operation for the DTX period according to the NES operation (e.g., DTX operation) and/or resources (e.g., channel) to which the transmission stop operation of the network node is applied. The terminal(s) 901 and 901-1 may perform a monitoring operation, transmission operation, reception operation and/or measurement operation for each application unit (e.g., base station, cell, radio access point, BWP, frequency, carrier, antenna and/or transmission beam) of the NES operation.

The central control unit (e.g., central control device) 904 may indicate the network nodes 902-2 and 903-1 performing the NES operations to release the NES operations (S908). The network nodes 902-2 and 903-1 may receive information indicating to release the NES operation from the central control unit (e.g., central control device) 904. An entity and/or protocol layer responsible for the NES operation of the network node (e.g., base station, cell, radio access point, TRP) may determine (e.g., decide) to release the NES operation (S909). The network node may decide to release the NES operation upon receipt of an uplink signal/channel from the terminal. Alternatively, the network node may decide to release the NES operation upon receipt of information indicating to release the NES operation from the central control unit (e.g., central control device) 904.

When a process for the NES operation is configured, release of the NES operation in step S909 may be performed on the basis of the NES operation process. The network node (e.g., base station, cell, radio access point, TRP) may transmit an NES control message indicating to release the NES operation to the terminal(s) 901 and 901-1 (S910). The indication to release the NES operation may refer to deactivation indication of the NES operation. The deactivation indication of the NES operation may be transmitted through an RRC signaling message and/or an L1 message (e.g., DCI, L1 group common signaling message). In step S910, the NES control message indicating to release the NES operation may be selectively transmitted. The NES control message indicating to release the NES operation in step S910 may be an RRC message, MAC CE, and/or DCI. In step S910, the network node (e.g., base station, cell, radio access point, TRP) may transmit control information (e.g., indicator) including the process identifier of the NES operation to the terminal(s) 901 and 901-1 to inform the terminal(s) 901 and 901-1 of the release of the NES operation corresponding to the process identifier.

After step S909 and/or S910, the network node may provide services using the multiple radio access point-based function to the terminal(s) 901 and 901-1 according to conditions and/or parameters for support of the multiple radio access point-based function (S911). In other words, the network node may provide multiple TRP-based services to the terminal(s) 901 and 901-1. The terminal(s) 901 and 901-1 may receive services using the multiple radio access point-based function according to conditions and/or parameters for support of the multiple radio access point-based function. When a control message (e.g., NES control message) indicating to release the NES operation is received from the network node (e.g., base station, cell, radio access point) in step S910, the terminal 901-1 in the RRC inactive state or RRC idle state may maintain configuration of parameters (e.g., SPS resource allocation, CG resource allocation information, DRX parameters, system information) configured or stored in the terminal 901-1 to support other operations (e.g., DRX operation, small data transmission (SDT), etc.), and perform operations according to the state of the terminal 901-1.

If the terminal(s) 901 and 901-1 can recognize a time of releasing the NES operation based on configuration (e.g., parameters) for the NES operation, step S910 may be omitted. In other words, the terminal(s) 901 and 901-1 may recognize (e.g., identify) a time of stopping and/or releasing the NES operation (e.g., DTX operation, transmission stop operation) based on configuration for the NES operation (e.g., a (re) start time of transmission of the network node, DTX cycle, on-duration of the DTX operation, active time of the DTX operation), and may perform the restricted operation (e.g., monitoring operation, reception operation, transmission operation, measurement operation) again after the NES operation is stopped and/or released. The restricted operation of the terminal(s) may be performed again without receiving a signaling message in step S910. The restricted operation may be the stopped operation.

The control message notifying that the NES operation is performed in step S905 and/or the control message notifying release of the NES operation in step S910 may be transmitted to the terminal(s) 901 and 901 through the first radio access point 902-1 instead of the second radio access point 902-2 and/or the third radio access point 903-1. In step S906, the uplink transmission (e.g., transmission of NES feedback information and/or transmission of an RA message according to an RA procedure) of the terminal(s) 901 and 901-1 may be performed for the first radio access point 902-2 instead of the second radio access point 902-2 and/or the third radio access point 903-1.

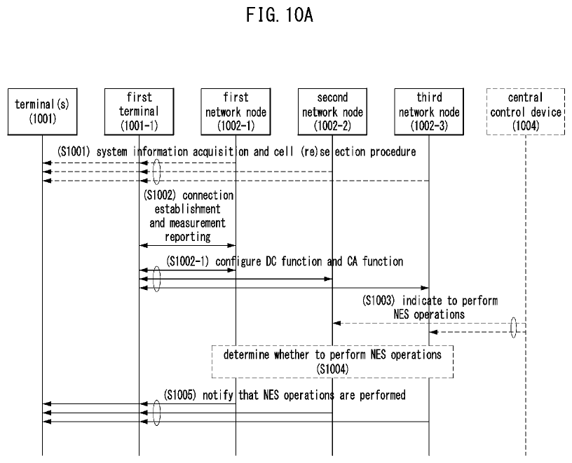

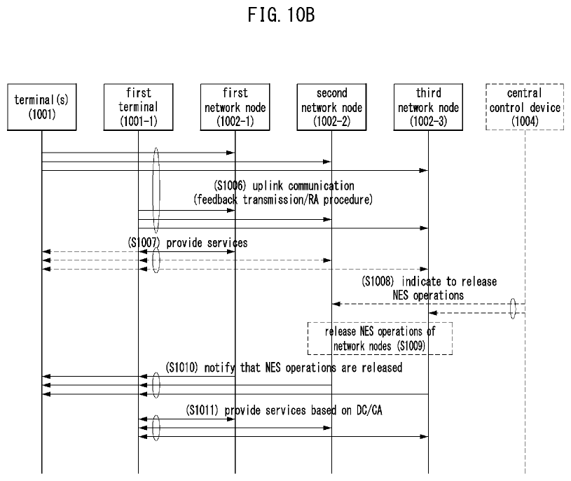

FIGS. 10A and 10B are sequence charts illustrating exemplary embodiments of an NES operation.

Referring to FIGS. 10A and 10B, an NES operation may be performed considering carrier aggregation (CA) or dual connectivity (DC). Terminal(s) 1001 may operate in the RRC inactive state or the RRC idle state. In step S1001, the terminal(s) 1001 may receive system information from network node(s) 1002-1, 1002-2, and 1002-3, perform a measurement operation based on the system information, and perform a cell (re) selection procedure based on results of the measurement operation. In step S1001, the terminal(s) 901 may select a first optimal network node 1002-1 by performing the cell (re) selection procedure, and camp on the selected first optimal network node 1002-1. In step S1001, the terminal(s) 1001 in the RRC inactive state or RRC idle state may obtain control information for NES operation.

In step S1002, a first terminal 1001-1 among the terminal(s) 1001 may perform an RA procedure to the first network node 1002-1, and may establish an RRC connection with the first network node 1002-1 based on the RA procedure. When establishment of the RRC connection is completed, the operation state of the first terminal 1001-1 may transition to the RRC connected state. In step S1002, the first terminal 1001-1 may receive services through the first network node 1002-1 based on connection configuration parameters. In step S1002, the first terminal 1001-1 may report a measurement result of a service quality according to Condition 2 (e.g., Condition 2 defined in Table 1) to the first network node 1002-1.

In step S1002-1, the first terminal 1001-1 may configure the second network node 1002-2 as an SCell based on the CA function. In step S1002-1, the first terminal 1001-1 may configure the third network node 1002-3 as a secondary node based on the DC function. Step S1002-1 may be performed based on the signaling operation in step S1002 and/or an additional signaling operations after step S1002. When the CA function and/or DC function is configured in the first terminal 1001-1, a specific network node (e.g., the first network node 1002-1 where an RRC layer controlling the first network node 1002-1 and the second network node 1002-2 exists) may serve as a master node for the DC function and/or a primary cell (PCell) for the CA function.

While the CA function is supported, application of the NES operation to a primary cell (PCell) may be excluded (e.g., restricted). While the DC function is supported, application of the NES operation to a primary cell (PCell) of a master node (e.g., primary cell group), a primary cell (PSCell) of a secondary node (e.g., secondary cell group), and/or a special cell may be excluded (e.g., restricted). The special cell may refer to a cell for which a contention-based RA procedure and/or a physical uplink control channel (PUCCH) is configured. The NES operation (e.g., transmission stop operation and/or DTX operation of the network node) for the above-described cell(s) (e.g., PCell, PSCell, and/or special cell) may not be performed. Alternatively, the NES operation for the cell(s) may be limited to a specific unit (e.g., base station, cell, radio access point, BWP, frequency, carrier, antenna, transmission beam).

In step S1003, the central control unit (e.g., central control device) 904 may transmit information indicating to perform the NES operation to the second network node 1002-2 and the third network node 1002-3. Alternatively, step S1004 may be performed instead of step S1003. In step S1004, the network node(s) may determine whether to perform the NES operation based on a preconfigured condition (e.g., parameters).

If a process for the NES operation is configured, whether or not the NES operation is performed may be determined on a process basis in step S1004. The second network node 1002-2 and the third network node 1002-3 may determine to perform the NES operation based on a result of step S903 and/or a result of step S904. In step S1005, the second network node 1002-2 and the third network node 1002-3 may indicate (e.g., notify) the terminal(s) 901 and 901-1 within the service coverage to perform the NES operation. The indication to perform the NES operation may mean activation indication of the NES operation. The activation indication of the NES operation may be transmitted through an RRC signaling message and/or an L1 message (e.g., DCI, L1 group common signaling message). In step S1005, an NES control message notifying that the NES operation is performed may include a process identifier of the NES operation. In step S1005, the second network node 1002-2 and the third network node 1002-3 may transmit control information, process identifier, and/or indicator for the NES operation to the terminal(s) 1001 and 1001-1.

The NES control message transmitted to the terminal(s) 1001 and 1001-1 in step S1005 may be an RRC message (e.g., RRC control message), MAC message (e.g., MAC CE), and/or PHY message (e.g., DCI, field(s) within DCI, parameter(s) within DCI). If a process of the NES operation is configured, the NES control message may include a process identifier of the NES operation. The NES control message (e.g., RRC messages, MAC CE, and/or DCI) may include at least one of identifier information (e.g., identifier of a base stations, cell, radio access point, BWP, frequency, carrier, antenna, and/or transmission beam), process identifier of the NES operation, uplink resource allocation information for NES feedback information transmission, uplink resource allocation information for performing an access procedure, time information for the NES operation, timer information, periodicity (e.g., cycle) of the NES operation, or identification information to identify a service to which the NES operation is applied.

The identifier information (e.g., identifier of a base station, cell, radio access point, BWP, frequency, carrier, antenna, and/or transmission beam) included in the NES control message may indicate a target for which the NES operation is not performed (e.g., a target to which the NES operation is not applied). In this case, the terminal(s) 1001 and 1001-1 may distinguish between a network node that performs the NES operation and a network node that does not perform the NES operation based on the information included in the NES control message.

After step S1005, the network node (e.g., base station, cell, radio access point, TRP) performing the NES operation may perform a monitoring operation and/or a reception operation on uplink resources. The network node may receive a connection release control message (e.g., RRC release message), and a monitoring operation and/or reception operation on uplink resources may be performed based on information obtained through the connection release control message. The uplink resources may include uplink resources allocated for NES feedback information transmission, uplink resources allocated for an access procedure (e.g., RA procedure), and/or uplink resources configured for reception during the DTX operation. The network node may receive an RA message (e.g., RA preamble) and/or NES feedback information requesting to stop the NES operation by performing the monitoring operation and/or reception operation on the uplink resources.

Through the signaling operation in step S1005 and/or a separate signaling operation before step S1006, the network node 1002-1, 1002-2 and 1002-3 may transmit control information indicating to release, disable, or suspend an SPS allocation for downlink resources and/or a CG allocation for uplink resources configured in the terminal(s) 1001 and 1001-1. The control information indicating to release, disable, or suspend resources allocated in the SPS and/or CG scheme may be transmitted to the terminals 1001 and 1001-1 through at least one of an RRC control message, MAC CE, or DCI (e.g., field(s) and/or parameter(s) within DCI). The control information may include information (e.g., identification information) indicating resources allocated in the SPS and/or CG scheme that are subject to the release, disable, or suspension.

The terminal(s) 1001 and 1001-1 may receive a control message indicating to release, disable, or suspend resources allocated in the SPS and/or CG scheme. The terminal(s) 1001 and 1001-1 may deactivate or stop a monitoring operation and/or reception operation on SPS resources based on the control message. The terminal(s) 1001 and 1001-1 may deactivate or stop a transmission operation on CG resources based on the control message. The terminal(s) 1001 and 1001-1 may release configuration of the SPS resources and/or CG resources.

If service provision from the second network node 1002-2 and/or third network node 1002-3 is required, in step S1006, the terminal(s) 1001 (e.g., terminal(s) in the RRC connected state) may perform a transmission procedure of NES feedback information or an RA procedure (e.g., access procedure) before a transmission stop timer (e.g., transmission stop start timer, transmission stop condition timer) or a DTX inactivity timer expires.

The first terminal 1001-1 in the RRC inactive state or RRC idle state and/or the terminal(s) 1001 in the RRC connected state that do not receive scheduling of uplink resources may perform a transmission procedure of NES feedback information or an RA procedure (e.g., access procedure) in uplink resource(s) indicated by control information (e.g., uplink resource allocation information for NES feedback information transmission and/or an access procedure) for a transmission stop operation, which is obtained through step S1001, step S1005, and/or connection release message (e.g., RRC release message), uplink resource(s) indicated by control information for DTX operation (e.g., uplink resource allocation information configured for reception from the terminal during the DTX operation), and/or uplink resource(s) allocated for an RA procedure.

In step S1006, the terminal(s) 1001 and 1001-1 may indicate a preference for performing an NES operation associated with a process having a process identifier by transmitting the process identifier of the NES operation. For example, depending on system configuration, the process identifier transmitted by the terminal may explicitly or implicitly indicate the terminal's preference or NES feedback information on whether the terminal prefers to perform or exclude the NES operation corresponding to the process with the process identifier.

After step S1005, the network node(s) 1002-1, 1002-2, and 1002-3 may receive NES feedback information for NES operation or an RA message (e.g., RA preamble) for an RA procedure from the terminal(s) 1001 and 1001-1. In this case, the network node(s) 1002-1, 1002-2, and 1002-3 may not perform the NES operation. The network node(s) 1002-1, 1002-2, and 1002-3 that do not perform the NES operation may perform step S1009 without performing step S1007.

The second network node 1002-2 and/or third network node 1002-3 may support DC functions and/or CA functions. The second network node 1002-2 and/or third network node 1002-3 may notify the terminal(s) 1001 and 1001-1 that the NES operation is performed. When information indicating to perform the NES operation is received from the second network node 1002-2 and/or third network node 1002-3, the terminal(s) 1001 and 1001-1 may receive services from the first network node 1002-1 that does not perform the NES operation. In other words, in step S1007, the first network node 1002-1 that does not perform the NES operation may provide services to the terminal(s) 1001 and 1001-1. In step S1007, the second network node 1002-2 and/or third network node 1002-3 performing NES operations may provide restricted services to the terminal(s) 1001 and 1001-1.

The second network node 1002-2 and/or third network node 1002-3 may perform a transmission stop operation and/or DTX operation on a base station, cell, radio access point, BWP, frequency, carrier, antenna, and/or transmission beam basis. Therefore, services provided by the second network node 1002-2 and/or third network node 1002-3 to the terminal(s) 1001 and 1001-1 may be restricted on a base station, cell, radio access point, BWP, frequency, carrier, and/or transmission beam basis. The terminal(s) 1001 and 1001-1 may perform a monitoring operation, transmission operation, and/or reception operation on channels in an on-duration and/or active time according to the DTX operation. For a base station, cell, radio access point, BWP, frequency, carrier, antenna, and/or transmission beam to which the transmission stop operation is not applied, the terminal(s) 901 and 901-1 may perform a monitoring operation, transmission operation, and/or reception operation on channels.

In step S1007, the DC function and/or CA function configured in the terminal may not be released. In step S1007, service provision (e.g., exchange of control signaling messages and/or exchange of data (e.g., packets)) using a DTX period according to the NES operation (e.g., DTX operation) and/or resources (e.g., channels) to which the transmission stop operation of the network node is applied may be stopped. The terminal(s) 1001 and 1001-1 may not perform a monitoring operation, transmission operation, reception operation, and/or measurement operation in the DTX period according to the NES operation (e.g., DTX operation) and/or resources (e.g., channels) to which the transmission stop operation of the network node is applied. The terminal(s) 1001 and 1001-1 may not perform the monitoring operation, transmission operation, reception operation, and/or measurement operation for an application unit (e.g., base station, cell, radio access point, BWP, frequency, carrier, antenna, and/or transmission beam) to which the NES operation is applied.

The central control unit (e.g., central control device) 1004 may indicate the network nodes 1002-2 and 1002-3 performing the NES operations to release the NES operations (S1008). The network nodes 1002-2 and 1002-3 may receive information indicating to release the NES operations from the central control unit (e.g., central control device) 1004. An entity and/or protocol layer responsible for the NES operation in each of the network nodes 1002-2 and 1002-3 may determine (e.g., decide) to release the NES operation (S1009). The network node may decide to release the NES operation upon receipt of an uplink signal/channel from the terminal. Alternatively, the network node may decide to release the NES operation upon receipt of information indicating to release the NES operation from the central control unit (e.g., central control device) 1004.

If a process for the NES operation is configured, release of the NES operation in step S1009 may be performed in units of the NES operation process. The network node may transmit an NES control message indicating to release the NES operation to the terminal(s) 1001 and 1001-1 (S1010). The indication to release the NES operation may mean deactivation indication of the NES operation. The deactivation indication of the NES operation may be transmitted through an RRC signaling message and/or an L1 message (e.g., DCI, L1 group common signaling message). The NES control message indicating to release the NES operation in step S1010 may be selectively transmitted. The NES control message indicating to release the NES operation in step S1010 may be an RRC message, MAC CE, and/or DCI. In step S1010, the network node(s) may transmit control information (e.g., indicator) including the process identifier of the NES operation to the terminal(s) 1001 and 1001-1 to indicate the terminals 1001 and 1001-1 to release the NES operation corresponding to the process identifier.

After step S1009 and/or S1010, the network node may provide services using the CA function and/or DC function to the terminal(s) 1001 and 1001-1 according to parameters for support of the CA function and/or DC function (S1011). In other words, the network node may provide CA and/or DC-based services to the terminal(s) 1001 and 1001-1. The terminal(s) 1001 and 1001-1 may receive services using the CA function and/or DC function according to the parameters for support of the CA function and/or DC function. When a control message (e.g., NES control message) indicating to release the NES operation is received from the network node in step S1010, the terminal 1001-1 in the RRC inactive state or RRC idle state may maintain configuration of parameters (e.g., resource allocation information for SPS, resource allocation information for CG, DRX parameters, system information) configured or stored in the terminal 1001-1 to support other operations (e.g., DRX operation, SDT, etc.), and may perform operations according to the state of the terminal 1001-1.

If the terminal(s) 1001 and 1001-1 can recognize a time of releasing the NES operation based on configuration (e.g., parameters) for the NES operation, step S1010 may be omitted. In other words, the terminal(s) 1001 and 1001-1 may recognize (e.g., identify) a time of stopping and/or a time of releasing the NEX operation (e.g., DTX operation, transmission stop operation) based on the configuration for the NES operation (e.g., a (re) start time of transmission of the network node, DTX cycle, on-duration of DTX operation, active time of DTX operation), and may perform restricted operations (e.g., monitoring operation, reception operation, transmission operation, measurement operation) again after the NES operation is stopped and/or released. gain. The restricted operations of the terminal(s) may be performed again without receiving a signaling message in step S1010. The restricted operations may be operations stopped according to the NES operation.

The control message notifying that the NES operation is performed in step S1005 and/or the control message notifying release of the NES operation in step S1010 may be transmitted to the terminal(s) 1001 and 1001-1 through the first network node 1 1002-3 instead of the second network node 1002-2 and/or third network node 1002-3. In step S1006, uplink transmission (e.g., transmission of NES feedback information and/or transmission of an RA message according to an RA procedure) of the terminal(s) 1001 and 1001-1 may be performed for the first network node 1002-1 instead of the second network node 1002-2 and/or third network node 1002-3.

In the present disclosure, a network node performing the NES operation (e.g., transmission stop operation, DTX operation, DRX operation, etc.) and/or a network node supporting the NES operation may be referred to as a NES network node (e.g., NES node). A network node may be interpreted as an NES network node or a network node that does not perform/support NES operations (e.g., non-NES network node) depending on a context. In other words, a network node may have meaning including a NES network node and/or a non-NES network node.

An NES network node may transmit SSB(s) (e.g., synchronizations signal) and/or system information (e.g., MIB, SIB1, other SIB) by using a minimum bandwidth or BWP (e.g., minimum BWP and/or default BWP). The NES network node may transmit SSBs and/or system information discretely. The discrete transmission of SSBs may mean discontinuous transmission of the SSBs. In other words, SSBs may be transmitted discontinuously at a periodicity. For example, if the periodicity (e.g., cycle) of SSBs is 20 ms, the network node may transmit SSB(s) in a period of 20 ms and may not transmit SSB(s) in the next period of 20 ms. The NES network node may repeat discontinuous transmission of SSB(s). The periodicity of SSB(s) may refer to a generation periodicity, a transmission periodicity, and/or a reception periodicity. The NES network node may indicate the periodicity of SSB(s) to a terminal using at least one of MIB (e.g., field(s) and/or parameter(s) within MIB), system information, or control message (e.g., dedicated control message).

When the periodicity of SSB(s) is indicated (e.g., set) by system information and/or control message, the system information may be system information for adjacent cell(s) and/or system information including NES information, and the control message may be a control message for NES information. The periodicity of SSB(s) may be implicitly indicated by a function and/or modulo operation based on a cell identifier, PSS, and/or SSS. Alternatively, the periodicity of SSB(s) may be implicitly indicated by type information of SSB (e.g., block type information) in the MIB. When the periodicity of SSB(s) is implicitly indicated (e.g., signaled), the terminal may identify the periodicity of SSB(s) using the type information of SSB, cell identifier, PSS, and/or SSS in an SSB reception procedure. For example, when a modulo operation is used and the maximum number of configurable periodicities (e.g., forms) is 2, the network node and/or terminal may identify that the periodicity of SSB(s) is 20 ms when a result of the modulo operation using 2 (e.g., cell identifier modulo 2) is 0, and identify that the periodicity of SSB(s) is 40 ms when a result of modulo operation using 2 (e.g., cell identifier modulo 2) is 1.

The NES network node may stop the NES operation for transmission of system information, paging message, and/or emergency disaster message. After stopping the NES operation, the network node may transmit system information, paging message, and/or emergency disaster message. For example, a network node performing a DTX operation may transmit system information, paging message, and/or emergency disaster message in an on-duration and/or active time according to a DTX cycle.

In order to restrict camping of a terminal through an access procedure and/or cell (re) selection procedure, an NES network node may transmit, to the terminal, control information (e.g., indicator) indicating a bar (e.g., cell bar), access exclusion, and/or camping exclusion. The configuration information indicating the bar, access exclusion, and/or camping exclusion to restrict the camping of the terminal through an access procedure and/or cell (re) selection procedure may be configured or transmitted on a cell or radio access point basis. In the exemplary embodiment of FIG. 9, control information (e.g., indicator) indicating a bar, access exclusion, and/or camping exclusion for the first radio access point 902-1 and the second radio access point 902-2 may be transmitted by the second radio access point 902-2. In other words, the first radio access point 902-1 may not transmit control information (e.g., indicator) indicating the bar, access exclusion, and/or camping exclusion.

In order to determine whether to perform the NES operation based on presence or absence of terminal(s) within a service coverage and/or a request from a terminal, the NES network node may perform a monitoring operation and a reception operation for an RA channel of the NES network node and/or an adjacent network node. The NES network node may obtain RA configuration information of the adjacent network node by exchanging control messages with the adjacent network node. The NES network node may perform a monitoring operation on an RA channel of the adjacent network node using the RA configuration information of the adjacent network node. Based on a result of the monitoring operation on the RA channel, the NES network node may recognize (e.g., identify) an access request of a terminal. Based on the result of the monitoring operation on the RA channel, the NES network node may measure a received power and/or channel quality (e.g., RSSI, RSRP, RSRQ, etc.) for an uplink channel, and based on a result of the measurement, the NES network node may determine (e.g., decide) whether to stop the NES operation in order to provide services to the terminal and/or support camping of the terminal through a cell (re) selection procedure.

In the cell (re) selection procedure for camping, a terminal in the RRC inactive state and/or RRC idle state may identify the NES network node based on the method described above. The terminal may exclude the NES network node from targets of the cell (re) selection procedure. Alternatively, the terminal may set (e.g., manage) a priority of the NES network node to a low priority. Based on the indicator indicating whether the NES operation is supported and/or the indicator indicating whether the NES operation is performed, the terminal may obtain information on whether the NES operation is supported (e.g., performed).

The terminal in the RRC inactive state and/or RRC idle state may not discover a network node that meets a condition of the cell (re) selection procedure for a camping cell. In this case, the terminal may perform an RA procedure to the NES network node. The terminal may transmit a request to stop the NES operation to the NES network node. The terminal may obtain RA configuration information of the NES network node from an adjacent network node. In other words, each of the NES network node and the adjacent network node may obtain the RA configuration information of the other network node by performing a control message exchange procedure. The adjacent network node may transmit system information and/or a control message (e.g., dedicated control message) including RA configuration information of the NES network node to the terminal. The terminal in the RRC inactive state and/or RRC idle state may perform an RA procedure to the NES network node and/or request to stop the NES operation for the NES network node based on the RA configuration information of the NES network node obtained from the adjacent network node.

For the NES operation, the network node may perform a counting procedure to determine a need to maintain service provision for terminals within the service coverage. In the counting procedure, the network node may check whether a terminal in the RRC connected state is to receive services from the network node even in a situation where a service level (e.g., service quality) changes due to the NES operation. In the counting procedure, the network node may check whether a terminal in the RRC inactive state and/or RRC idle state is to maintain camping on the network node even in a situation where a service level (e.g., service quality) changes due to the NES operation.

For the counting procedure, the network node may transmit a control message notifying a start of the counting procedure to a terminal within the service coverage before performing the NES operation. The terminal may receive the control message notifying the start of the counting procedure, and may transmit response information and/or NES feedback information to the network node in response to the control message. The control message notifying the start of the counting procedure may be at least one of an RRC message, MAC CE, or DCI. Each of the response information and NES feedback information in response to the control message notifying the start of the counting procedure may be included in an RA preamble, RA message, MAC CE, and/or RRC message.

The response information and/or NES feedback information in response to the control message notifying the start of the counting procedure may include information indicating whether the terminal is to receive services from the NES network node, information indicating whether the terminal maintains camping on the NES network node, and/or information on a preference for whether or not to perform the NES operation of the network node. The network node may decide whether to perform the NES operation by considering a result of the counting procedure. The network node may determine (e.g., indicate) whether to perform a handover, redirection to another intra-RAT network node, and/or redirection to another inter-RAT network node for a terminal in the RRC connected state by considering the result of the counting procedure.

The NES operation may be applied to a booster node (e.g., booster network node) that performs a service coverage extension function and/or a secondary network function. A primary cell (PCell) for the CA function and/or a special cell (SpCell) for the DC function may not perform the NES operation. The special cell (SpCell) may refer to a primary cell (PCell) within a master cell group (MCG) and a primary secondary cell (PSCell) within a secondary cell group (SCG) to support the DC functions. The booster node may be a network node for covering the entire service coverage and/or a network node for service coverage expansion at a cell boundary. The booster node may refer to secondary cell(s) for support of the CA function and/or DC function and/or radio access point(s) belonging to the secondary cell(s). The booster node may be configured (e.g., controlled) to perform the NES operation. Configuration information (e.g., parameters) for the NES operation may be transmitted to the terminal using a control message to support the CA function and/or DC function. The configuration information (e.g., parameters) for the NES operation may be transmitted to the terminal using a control message for configuring the booster node for service coverage expansion.

Booster nodes belonging to the same timing advance group (TAG) among cell groups supporting the CA function and/or DC function (e.g., cells that do not belong to the PCell for the CA function and/or the special cells for the DC function, and/or radio access point(s) belonging to the cell(s)) may not transmit SSB(s). Alternatively, the booster node may perform the NES operation without restrictions due to SSB transmission. In other words, the NES operation may be performed (e.g., applied) in the cell (e.g., SCell) not transmitting SSB(s). The cell not transmitting SSB(s) may be an SSB-less cell (SCell). In the DTX operation of the network node, the booster node may set a DTX cycle without restrictions on the periodicity of SSBs (e.g., 20 ms). The booster node may not set a DTX cycle to multiples of 20 ms. The booster node may set a DTX cycle to a periodicity greater than 80 ms.

The NES operation of the booster node may be applied to the terminal in the RRC connected state. An access procedure to the booster node may be restricted in a terminal in the RRC inactive state and/or RRC idle state. The access procedure by the terminal in the RRC inactive state and/or RRC idle state may be restricted by bar configuration (e.g., cell bar configuration). The access procedure by the terminal in RRC inactive state and/or RRC idle state may be restricted by transmission of an SSB (e.g., non-cell defining (CD) SSB) that is not associated with SIB1 and/or remaining minimum system information (RMSI). To improve the performance of the NES operation of the booster node, the same parameters may be applied to all terminals and/or a terminal group to which services are provided. In other words, the booster node may apply parameters for NES operation (e.g., a start time of transmission stop operation, a release time of transmission stop operation, DTX cycle, etc.) equally to all terminals and/or a terminal group to which services are provided.

In the NES operation, execution of the NES operation may be excluded in resources (e.g., radio resources) indicated by at least one index among various indices for identifying an application unit of the NES operation (e.g., indication information and/or index for a base station, cell, radio access point, BWP, frequency, carrier, antenna, and/or transmission beam) of at least one network node and/or a specific network node. When the NES operation is performed on a radio access point basis, at least one radio access point among radio access points providing services to the terminal may not perform the NES operation. When the NES operation is performed on an antenna basis, at least one antenna (e.g., one MIMO layer, one antenna port, and/or one antenna) among antennas configured for providing services to the terminal may not perform the NES operation.

A priority for a cell, frequency, carrier, and/or radio access point to which the NES operation is applied may be set differently in a cell (re) selection procedure of the terminal in the RRC inactive state and/or RRC idle state. The cell (re) selection procedure may be performed based on the priority. Depending on configuration of the network, configuration of the terminal, and/or configuration of a user, the terminal in the RRC inactive state and/or RRC idle state may set a priority for a cell, frequency, carrier, and/or radio access point to which the NES operation is applied to a low priority. The terminal in the RRC inactive state and/or RRC idle state may preferentially select and camp on a cell, frequency, carrier, and/or radio access point to which NES operation is not applied. Alternatively, the terminal in the RRC inactive state and/or RRC idle state may set a priority for a cell, frequency, carrier, and/or radio access point to which the NES operation is applied to a high priority. The terminal in the RRC inactive state and/or RRC idle state may preferentially select and camp on a cell, frequency, carrier, and/or radio access point to which the NES operation is applied.

The DTX cycle (e.g., cycle for DTX operation) and/or DTX on-duration (e.g., on-duration for DTX operation) may be configured considering a DRX cycle (e.g., cycle for DRX operation) and/or DRX on-duration (e.g., on-duration for DRX operation) configured by the network node to terminal(s) within the service coverage. The parameter(s) for the cell DTX operation may be set so that the DTX operation (e.g., cell DTX operation) of the network node is aligned with the DRX operation (e.g., UE DRX operation) of the terminals.

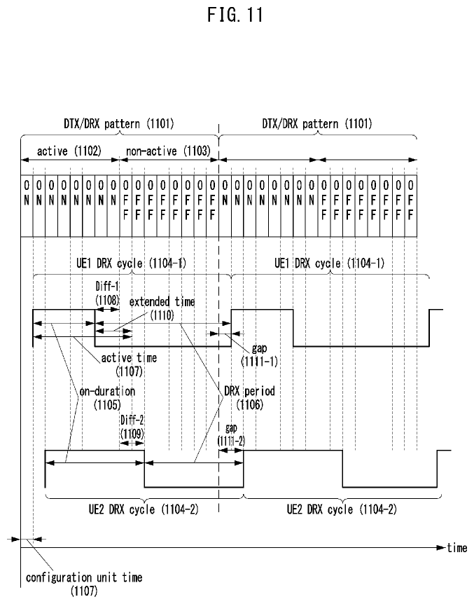

FIG. 11 is a conceptual diagram illustrating exemplary embodiments of DTX/DRX operations in a communication network.

Referring to FIG. 11, a DTX/DRX operation of a network node for support of NES operation may be aligned with a UE DRX operation. A DTX/DRX cycle of the network node may be set in one subframe or multiple subframes. The DTX/DRX operation of the network node may be referred to as a network node (ND) DTX/DRX operation. The ND DTX/DRX operation may mean a cell DTX/DRX operation. The cell DTX/DRX operation may include a cell DTX operation and/or a cell DRX operation. A DRX operation of a terminal may be referred to as a UE DRX operation. A time region for each of the cell DTX/DRX operation and the UE DRX operation may be configured using a minimum configuration unit time 1107 (e.g., slot, symbol, and/or a plurality of symbols). To support an NES operation according to a DTX/DRX pattern 1101, it may be determined whether the network node performs a transmission operation and/or a reception operation.

The DTX/DRX pattern 1101 of the network node may include an active period (i.e. active time) 1102 and/or a non-active period (i.e. inactive time) 1103. In the active period 1102, the network node may perform a transmission operation and/or reception operation. In the non-active period 1103, the network node may not perform a transmission operation and/or reception operation. In the UE DRX operation, a DRX cycle 1104-1 or 1104-2 may be set for each terminal. A UE1 DRX cycle 1104-1 may be a DRX cycle for a first terminal, and a UE2 DRX cycle 1104-2 may be a DRX cycle for a second terminal. The terminal may perform a monitoring operation and/or a reception operation for a downlink signal/channel of the network node in an on-duration 1105 according to the UE DRX operation. The terminal may not perform a monitoring operation and/or reception operation for a downlink signal/channel of the network node in a DRX period 1106.

If a transmission operation and/or reception operation of the terminal is not completed in the on-duration 1105 according to the UE DRX operation, the terminal may perform a transmission operation and/or reception operation in an extended period for the on-duration 1105. If an inactivity timer for the UE DRX operation (e.g., drx-InactivityTimer), a DRX retransmission timer (e.g., drx-RetransmissionTimerDL, drx-RetransmissionTimerUL, and/or drx-Retransmission TimerSL), and/or a timer defined for extending an active period for the NES network node (e.g., Cell-activePeriod-extension-timer) is not running (or expires), the terminal may perform a transmission operation and/or reception operation even after the on-duration according to the UE DRX operation ends.

The terminal may perform a transmission operation and/or a reception operation in the extended period including the on-duration 1105. The extended period may be an active time 1107. In the time domain, the active time 1107 may be configured to be equal to or longer than the on-duration 1105 of the terminal. The terminal may determine whether to perform a transmission operation and/or reception operation in the extended period including the active period 1102. A timer for the extended period may be referred to as an extended timer. The extended timer may be drx-Inactivity Timer, drx-Retransmission TimerDL, drx-Retransmission TimerUL, drx-RetransmissionTimerSL, and/or Cell-activePeriod-extension-timer.

The DTX/DRX pattern and/or DTX/DRX cycle of the terminal may not match a UE DRX pattern and/or UE DRX cycle. In other words, a start time and/or end time of each of the DTX/DRX pattern and DTX/DRX cycle of the network node may be different from a start and/or end time of each of the UE DRX pattern and UE DRX cycle. The DRX on-duration 1105 may partially overlap with an active period 1102 of the cell DTX/DRX pattern and/or the cell DTX/DRX cycle. The DRX on-duration 1105 may be an on-duration according to the DRX operation of the terminal. The cell DTX/DRX pattern may be a DTX/DRX pattern according to the cell DTX/DRX operation. The cell DTX/DRX cycle may be a DTX/DRX cycle according to the cell DTX/DRX operation. The DRX on-duration 1105 may be configured to be included in the active period 1102 of the cell DTX/DRX pattern and/or cell DTX/DRX cycle.

When the DRX on-duration 1105 partially overlaps with the active period 1102 of the cell DTX/DRX pattern and/or the cell DTX/DRX cycle, the DRX on-duration 1105 may not coincide with the active period 1102 of the network node. The DRX on-duration 1105 may end earlier by Diff-1 1108 than the active period 1102 of the network node. Alternatively, the DRX on-duration 1105 may end later by Diff-2 1109 than the active period 1102 of the network node.

If the DRX on-duration 1105 is configured to end earlier by Diff-1 1108 than the active period 1102 of the network node, the network node and/or terminal may operate as follows.

● When the extended timer expires (e.g., when the active time 1107 is not extended to be longer than the DRX on-duration 1105)

▪ The terminal may not perform a monitoring operation and/or reception operation for a downlink signals/channels in the active period 1102 of the network node.

▪ The network node may not perform a downlink transmission operation and/or an uplink reception operation for the terminal after the DRX on-duration of the terminal ends.

● When the extended timer does not expire (e.g., when the active time 1107 is extended to be longer than the DRX on-duration 1105):

▪ The terminal may perform a monitoring operation and/or reception operation for downlink signals/channels in the active period 1102 of the network node during the active time 1107.

▪ The network node may perform a downlink transmission operation and/or an uplink reception operation for the terminal in the active period 1102 of the network node in accordance with the active time 1107 of the terminal extended according to the operation of the extended timer.

The DRX active time 1107 of the terminal may extend from the active period 1102 of the network node up to an non-active period 1103. If the extended time 1110 for the active time 1107 of the UE DRX operation is extended up to the non-active period 1103 of the network node, operations of the network node (e.g., transmission operation) and/or the operation of the terminal (e.g., reception operation) during the non-active period 1103 of the network node and/or the extended time 1110 of the terminal may be as follows.

### <Operation for Downlink Signal/Channel>

When the non-active period 1103 begins, the network node may stop an initial transmission operation and/or retransmission operation for the terminal, and the terminal may stop a reception operation for downlink signals/channels. For initial transmission and/or retransmission of a downlink signal/channel, the network node and/or terminal may perform the following operations (e.g., restricted operations) in the non-active period 1103 according to configuration. Alternatively, the network node and/or terminal may selectively perform the following operation (e.g., limited operations) in the non-active period 1103.

● Operations of network node

▪ When the network node receives an HARQ NACK feedback from the terminal in the active period 1102

[symbol] The network node may perform a retransmission procedure for a transport block (TB) in the non-active period 1103. In other words, if transmission of data (e.g., TB) fails in the active period 1102, the network node may perform a retransmission procedure for the data in the non-active period 1103. When the extended timer is running, the network node may perform a retransmission procedure for a specific terminal. For example, a UE-specific retransmission procedure may be allowed. The TB may be referred to as a TrBK.

Information indicating whether to allow a UE-specific retransmission procedure of the network node in the non-active period 1103 may be signaled to the terminal by using an NES control message, L2 control message (e.g., MAC CE), and/or L1 control message (e.g., DCI). The retransmission procedure (e.g., UE-specific retransmission procedure) of the network node may be an optional procedure.

▪ When the network node allows the terminal to transmit an HARQ NACK feedback in the non-active period 1103 and receives the HARQ NACK feedback from the terminal in the non-active period 1103:

[symbol] Transmission of TB (e.g., TrBK) may be considered as a transmission failure of HARQ (e.g., HARQ feedback).

[symbol] The HARQ operation (e.g., HARQ retransmission operations) may be pending (e.g., sustained) until the next active period 1102 and/or a retransmission procedure may be performed in the next active period 1102 and/or DRX on-duration.

● Operations of terminal

▪ When the terminal transmits an HARQ NACK feedback to indicate whether reception of a downlink initial transmission received in the active period 1102 of the network node is successful

[symbol] When the terminal transmits an HARQ NACK feedback in the active period 1102

When an extended timer (e.g., retransmission timer) is running, the terminal may perform a PDCCH monitoring operation and/or a downlink signal/channel reception operation in the non-active period 1103 of the network node. In other words, the terminal may perform a reception operation of retransmission data in the non-active period 1103 of the network node.

[symbol] When the terminal is allowed to transmit an HARQ NACK feedback in the non-active period 1103, and the terminal transmits the HARQ NACK feedback to the network node in the non-active period 1103

Transmission of TB (e.g., TrBK) may be considered as a HARQ transmission failure.

The HARQ operation (e.g., HARQ retransmission operations) may be pending (e.g., sustained) until the next active period 1102 and/or a retransmission procedure may be performed in the next active period and/or DRX on-duration.

### <Operations for Uplink Signals/Channels>

When the non-active period 1103 begins, the network node may stop a reception operation for the terminal, and the terminal may stop an initial transmission operation and/or retransmission operation of an uplink signal/channel. For initial transmission and/or retransmission of an uplink signal/channel, the network node and/or terminal may perform the following operations (e.g., restricted operations) in the non-active period 1103 depending on a configuration. Alternatively, the network node and/or terminal may selectively perform the following operations (e.g., restricted operations) in the non-active period 1103.

● Operations of network node

▪ The network node may receive an uplink initial transmission from the terminal in the active period 1102, and may transmit an HARQ ACK/NACK feedback indicating whether reception of the uplink initial transmission is successful.

[symbol] If either ACK or NACK occurs, the network node may transmit an HARQ ACK/NACK feedback. If a reception result for the uplink initial transmission is ACK, the network node may transmit an ACK feedback. If a reception result for the uplink initial transmission is NACK, the network node may not transmit a NACK feedback. Alternatively, the network node may not transmit an ACK feedback, but may transmit a NACK feedback.

▪ When the network node transmits HARQ NACK feedback information for the initial transmission of the terminal in the active period 1102, or

▪ when the network node transmits HARQ NACK feedback information for the initial transmission of the terminal in the extended time 1110 for the non-active period 1103

[symbol] The network node may receive a HARQ retransmission packet (e.g., TB, TrBK) from the terminal through uplink resources allocated to the terminal for which HARQ retransmission is allowed in the active period 1103. In other words, retransmission of data in the non-active period 1103 may be allowed.

The uplink resources for HARQ retransmission in the non-active period 1103 may be configured in advance. Alternatively, the uplink resources for HARQ retransmission in the non-active period 1103 may be scheduled together in the step of transmitting HARQ NACK feedback information. A retransmission procedure may be allowed in uplink resources (e.g., PUSCH) allocated by dynamic scheduling of the network node in the non-active period 1103.

[symbol] When HARQ retransmission of the terminal is not allowed in the non-active period 1103

Transmission of TB (e.g., TrBK) may be considered as a HARQ transmission failure.

The HARQ operation (e.g., HARQ retransmission operations) may be pending (e.g., sustained) until the next active period 1102, and the network node may receive an HARQ retransmission packet (e.g., TB, TrBK) from the terminal by performing a reception operation for an uplink resource scheduled to the terminal in the next active period 1102 and/or DRX on-duration.

● Operations of terminal

▪ The terminal may perform initial transmission in the active period 1102 of the network node. If an extended timer runs after the initial transmission, the terminal may perform a reception operation of an HARQ ACK/NACK feedback from the network node. In other words, the terminal may perform a reception operation of an HARQ ACK/NACK feedback in an active time.

▪ When an HARQ NACK for the initial transmission of the terminal is received in the active period 1102 of the network node, or

▪ when the HARQ NACK for the initial transmission of the terminal is received in the extended time 1110 for the non-active period 1103 of the network node

[symbol] HARQ retransmission of the terminal may be allowed in the non-active period 1103. If there are an uplink resource for retransmission, the terminal may perform a HARQ retransmission procedure in the non-active period 1103. In other words, the terminal may retransmit data to the network node in the non-active period 1103.

[symbol] When HARQ retransmission of the terminal is not allowed in the non-active period 1103

Transmission of TB (e.g., TrBK) may be considered as a HARQ transmission failure.

The HARQ operation (e.g., HARQ retransmission operations) may be pending (e.g., sustained) until the next active period 1102, and the network node may perform an HARQ retransmission operation using an available uplink resource in the next active period 1102 and/or DRX on-duration.

If the DRX on-duration 1105 is configured to end later by Diff-2 1109 than the active period 1102 of the network node, the network node and/or terminal may operate as follows.

### <Operations for Downlink Signals/Channels>

When the non-active period 1103 starts, the network node may stop an initial transmission operation and/or retransmission operation for the terminal, and the terminal may stop a reception operation of downlink signal/channel. Even in the non-active period 1103, the network node may perform an initial transmission operation and/or a retransmission operation for a downlink signal/channel within the on-duration 1105. The network node may selectively perform a retransmission operation in the non-active period 1103. The network node may perform a retransmission operation in the non-active period 1103 according to a configuration.

### <Operations for Uplink Signals/Channels>

When the non-active period 1103 begins, the network node may stop a reception operation from the terminal, and the terminal may stop an initial transmission operation and/or retransmission operation for an uplink signal/channel. Even in the non-active period 1103, the terminal may perform an initial transmission operation and/or retransmission operation for an uplink signal/channel within the on-duration 1105. The terminal may selectively perform a retransmission operation in the non-active period 1103. The terminal may perform a retransmission operation in the non-active period 1103 according to a configuration.

If a NACK feedback is received during the extended time 1110 for the non-active period 1103 of the network node, transmission (e.g., HARQ transmission) of a packet (e.g., TB and/or TrBK) may be considered as a failure. Alternatively, if a NACK feedback is received in the extended time 1110 of the non-active period 1103 of the network node, a retransmission procedure based on the NACK feedback may be performed in the active time 1107 extended up to the non-active period 1103 and/or extended time 1110.

The HARQ operation (e.g., HARQ retransmission procedure) may be pending (e.g., sustained) until the next active period 1102. A retransmission procedure (e.g., HARQ retransmission procedure) may be performed in the next active period 1102 and/or DRX on-duration. If the HARQ retransmission procedure is pending (e.g., sustained) until the next active period, the non-active period of the network node may be terminated according to a configuration of the network node, a request of the terminal, a selective operation of the network node, and/or a selective operation of the terminal, and the HARQ retransmission procedure may be performed in a gap period 1111-1 or 1111-2 before a start of a DRX on-duration.

A transmission operation of HARQ ACK/NACK feedback information and/or a HARQ retransmission operation in the non-active period 1103 of the network node may be configured (e.g., indicated) by an NES control message. The network node may configure (or, indicate) a transmission operation of HARQ ACK/NACK feedback information and/or HARQ retransmission operation in the non-active period 1103 by using scheduling information (e.g., PDCCH, DCI) and/or MAC control message (e.g., MAC CE) in the active period 1102. The network node may indicate whether to allow (e.g., perform) a transmission operation of HARQ ACK/NACK feedback information and/or a HARQ retransmission operation in the active period 1103. In the initial transmission procedure of the terminal, retransmission for a packet (e.g., TB and/or TrBK) in the non-active period 1103 may be requested using L1/L2 parameters.

A terminal in the RRC inactive state may remain within the coverage of the NES network node based on the method(s) described above. In this case, configuration information configured by the NES network node in the terminal in the RRC inactive state may be maintained or released. For example, the network node may release configuration parameters in an RRC context (e.g., access stratum (AS) context) of the terminal in the RRC inactive state. The configuration parameters within the RRC context may mean configuration parameters for a resume procedure (e.g., resources for the resume procedure), SPS procedure (e.g., resources for the SPS procedure), CG procedure (e.g., resources for the CG procedure), and/or may a contention-free RA procedure (e.g., resources for contention-free RA procedure).

When the network node starts the NES operation according to an operation condition of the communication network, RRC configuration information (e.g., RRC parameters) configured in the terminal in the RRC inactive state may be released. Even if the network node performs the NES operation according to other operation conditions of the communication network (e.g., control of the network node), the RRC configuration information (e.g., RRC parameters) configured in the terminal in the RRC inactive state may be maintained. That the RRC configuration information (e.g., RRC parameters) is maintained may mean ‘when the network node stops the NES operation, the terminal in the RRC inactive state can use RRC configuration information (e.g., RRC parameters) obtained and/or resources configured before performing the NES operation’. The network node may transmit information (e.g., indicator, control information) indicating whether the terminal in the RRC inactive state performs an operation of releasing the RRC configuration information (e.g., RRC parameters), an operation of maintaining (e.g., storing) the RRC configuration information (e.g., RRC parameters), and/or an operation of using the maintained RRC configuration information (e.g., RRC parameters) to the terminal system information and/or a control message (e.g., dedicated control message).

The control method and procedure for NES operation described above may be applied not only to terrestrial network nodes installed on the ground, but also to non-terrestrial network nodes. The non-terrestrial network node may be a network node providing non-terrestrial network (NTN) services and/or unmanned aerial vehicle (UAV) services to the terminal through a link (e.g., wireless link) and/or channel (e.g., wireless channel).

The network node may transmit traffic, data, packets, control messages, control information, configuration information, system information, and/or reference signals to the terminal through a link and/or channel between the network node and the terminal. The reference signals may be configured for various functions and/or purposes. The network node may provide NTN services and/or UAV services to the terminal and receive uplink signals/channels from the terminal. The network node may transmit an NES control message, indicator, and/or control information to the terminal based on the NES function support method and/or NES operation method. The network node supporting NTN services and/or UAV services may receive the terminal's preference information for NES operation and/or NES feedback information from the terminal. The network node may perform an operation to support the NES function and/or NES operation based on the method(s) described above.

With respect to the operation of the timer defined or described in the present disclosure, although operations such as start, stop, reset, restart, or expire of the defined timer are not separately described, they mean or include the operations of the corresponding timer or a counter for the corresponding timer. The terminal may refer to a UE, a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a network node, comprising:
transmitting first control information to one or more terminals including a network energy saving (NES) terminal, the first control information including information on whether the NES terminal supporting an NES operation is allowed to perform an access procedure to the network node; and
in response to that the NES terminal is allowed to perform an access procedure to the network node, performing the access procedure with the NES terminal.

2. The method according to claim 1, wherein even when the NES terminal is allowed to perform an access procedure to the network node, an access procedure of a non-NES terminal that does not support the NES operation among the one or more terminals is restricted from being performed to the network node.

3. The method according to claim 1, wherein the first control information including the information on whether the NES terminal is allowed to perform an access procedure to the network node is a system information block (SIB).

4. The method according to claim 1, further comprising: transmitting, to the one or more terminals, second control information indicating activation of the NES operation, wherein the second control information is included in a radio resource control (RRC) signaling message or a layer (L1) group common signaling message.

5. The method according to claim 1, further comprising: transmitting, to the one or more terminals, third control information indicating deactivation of the NES operation, wherein the third control information is included in an RRC signaling message or an L1 group common signaling message.

6. The method according to claim 1, wherein the NES operation includes a cell discontinuous transmission (DTX)/discontinuous reception (DRX) operation, and an active period for the cell DTX/DRX operation partially overlaps an on-duration for a user equipment (UE) DRX operation.

7. The method according to claim 1, wherein the NES operation is applied to a cell where a synchronization signal block (SSB) is not transmitted.

8. The method according to claim 1, further comprising:
performing communication with the NES terminal in an active period for a cell DTX/DRX operation which is the NES operation; and
performing restricted communication with the NES terminal in a non-active period for the cell DTX/DRX operation.

9. The method according to claim 8, wherein the restricted communication includes at least one of a retransmission operation for data transmission failed in the active period, a retransmission operation when a retransmission timer is running in the inactive period, or a retransmission operation using an uplink resource allocated by dynamic scheduling of the network node in the inactive period.

10. A method of a first terminal, comprising:
receiving first control information from a network node, the first control information including information on whether a network energy saving (NES) terminal supporting an NES operation is allowed to perform an access procedure to the network node; and
in response to that an NES terminal is allowed to perform an access procedure to the network node, and the first terminal is an NES terminal, performing an access procedure to the network node.

11. The method according to claim 10, wherein the first control information including the information on whether an NES terminal is allowed to perform an access procedure to the network node is a system information block (SIB).

12. The method according to claim 10, further comprising: receiving, from the network node, second control information indicating activation of the NES operation, wherein the second control information is included in a radio resource control (RRC) signaling message or a layer (L1) group common signaling message.

13. The method according to claim 10, further comprising: receiving, from the network node, third control information indicating deactivation of the NES operation, wherein the third control information is included in an RRC signaling message or an L1 group common signaling message.

14. The method according to claim 10, wherein the NES operation includes a cell discontinuous transmission (DTX)/discontinuous reception (DRX) operation, and an active period for the cell DTX/DRX operation partially overlaps an on-duration for a user equipment (UE) DRX operation.

15. The method according to claim 10, wherein the NES operation is applied to a cell where a synchronization signal block (SSB) is not transmitted.

16. The method according to claim 10, further comprising:
performing communication with the network node in an active period for a cell DTX/DRX operation which is the NES operation; and
performing restricted communication with the network node in a non-active period for the cell DTX/DRX operation.

17. The method according to claim 16, wherein the restricted communication includes at least one of a retransmission operation for data transmission failed in the active period, a retransmission operation when a retransmission timer is running in the inactive period, or a retransmission operation using an uplink resource allocated by dynamic scheduling of the network node in the inactive period.

18. A first terminal comprising at least one processor, wherein the at least one processor causes the first terminal to perform:
receiving first control information from a network node, the first control information including information on whether a network energy saving (NES) terminal supporting an NES operation is allowed to perform an access procedure to the network node; and
in response to that an NES terminal is allowed to perform an access procedure to the network node, and the first terminal is an NES terminal, performing an access procedure to the network node.

19. The first terminal according to claim 18, wherein the NES operation includes a cell discontinuous transmission (DTX)/discontinuous reception (DRX) operation, and an active period for the cell DTX/DRX operation partially overlaps an on-duration for a user equipment (UE) DRX operation.

20. The first terminal according to claim 18, wherein the at least one processor further causes the first terminal to perform:
performing communication with the network node in an active period for a cell DTX/DRX operation which is the NES operation; and
performing restricted communication with the network node in a non-active period for the cell DTX/DRX operation,
wherein the restricted communication includes at least one of a retransmission operation for data transmission failed in the active period, a retransmission operation when a retransmission timer is running in the inactive period, or a retransmission operation using an uplink resource allocated by dynamic scheduling of the network node in the inactive period.
